(19) United States
(12) Patent Application Publication
(10) Pub. No.: US 2020/0254372 A1
(43) Pub. Date: Aug. 13, 2020

(54) NONWOVEN AIR FILTRATION MEDIUM

(71) Applicant: Georgia-Pacific Nonwovens LLC, Atlanta, GA (US)

(72) Inventors: Jacek K. Dutkiewicz, Cordova, TN (US); Brian Fong, Lakeland, TN (US); Jessica S. Flinn, Hernando, MS (US); Leonard E. Duello, Appleton, WI (US)

(21) Appl. No.: 16/651,829

(22) PCT Filed: Sep. 26, 2018
(86) PCT No.: PCT/US2018/052772

§ 371 Date: Mar. 27, 2020

Related U.S. Application Data
(60) Provisional application No. 62/564,103, filed on Sep. 27, 2017.

(51) Int. Cl. B01D 39/18; B01D 39/16

(52) U.S. Cl. CPC B01D 39/18; B01D 39/163; B01D 2239/1208; B01D 2239/0216; B01D 2239/1233; B01D 2239/0618; B01D 2239/0457; B01D 2239/1258; B01D 2239/064; B01D 2239/0681; B01D 2239/0478

(57) ABSTRACT

Air filtration media including synthetic and cellulose fiber layers are provided. More particularly, the air filtration media have high initial efficiency with improved durability, fire retardance, anti-microbial activity, and moisture resistance. The air filtration media can be used in air filters for a variety of applications.

### 1. RELATED APPLICATIONS

This application claims the benefit of priority to PCT patent application no. PCT/US2018/052772, filed Sep. 26, 2018, which claims priority to U.S. provisional patent application Ser. No. 62/564,103, filed Sep. 27, 2017, the disclosures of which are hereby incorporated by reference in their entirety.

### 2. FIELD OF THE INVENTION

The presently disclosed subject matter is directed to air filtration media that includes synthetic and cellulose fiber layers, which are characterized by a Fibrous Network Index (FNI). The air filtration media has many advantages, including high filtration and initial removal efficiency and can be used in air filters for a variety of applications.

### 3. BACKGROUND OF THE INVENTION

Air filters are used to remove particulate matter from air in a variety of applications, including residential, commercial, industrial, and laboratory applications. Air filters generally include an air filtration medium, disposed within or across the air filter, to remove solid particulate matter, but can also contain chemical components to absorb and/or neutralize odors.

Air filtration media can be made of a variety of materials, including paper, textiles, and foam. For example, air filters including a nonwoven air filtration medium have been used previously. However, such air filtration media are generally based on synthetic fibers. For example, U.S. Patent Publication No. 2004/0116026 discloses gradient nonwoven structures based on synthetic fibers that require a charge treatment in order to increase filter life through enhanced pressure drop and particle collection efficiency. Moreover, air filtration media based on synthetic fibers can require more material, resulting in a heavier substrate and increased expense.

Thus, it can be more desirable to include cellulose fibers, which are lighter, less expensive, and environmentally-friendly, into an air filtration medium. However, the use of cellulose fibers, particularly in large quantities, can have certain drawbacks, including poor microbial resistance and moisture sensitivity, resulting in mold growth and deterioration of the air filtration medium. Additionally, cellulose-based air filtration media are generally considered to have reduced durability and poor resistance to heat and flame.

Thus, there remains a need in the art for an air filtration medium that includes cellulose fibers while having improved durability, anti-microbial activity, moisture resistance, and flame retardance. The disclosed subject matter addresses these and other needs.

### 4. SUMMARY

The presently disclosed subject matter provides for an air filtration medium containing specific layered constructions, which advantageously achieves improved durability and initial removal efficiency, with enhanced anti-microbial activity, moisture resistance, and flame retardance.

In certain aspects, the present disclosure provides an air filtration medium comprising a first synthetic fiber layer comprising synthetic fibers and having a first FNI of from about 100 ft/(min %) to about 1000 ft/(min %) and a cellulose fiber layer having a second FNI that is lower than the first FNI, wherein the second FNI is from about 100 ft/(min %) to about 300 ft/(min %). For example, the synthetic fibers can comprise bicomponent fibers having an eccentric configuration with a sheath comprising polyethylene and a core comprising PET. The bicomponent fibers can have a core to sheath ratio of greater than 1:1. Alternatively or additionally, the bicomponent fibers can have an eccentric configuration with a sheath comprising polyethylene and a core comprising polypropylene.

In certain embodiments, the first synthetic fiber layer has a basis weight of from about 5 gsm to about 30 gsm, or from about 5 gsm to about 15 gsm, or from about 8 gsm to about 12 gsm. In certain embodiments, the cellulose fiber layer can have a basis weight of from about 25 gsm to about 100 gsm, or from about 25 gsm to about 45 gsm.

In certain embodiments, the first synthetic fiber layer can include bicomponent fibers having a first length and bicomponent fibers having a second length, wherein the second length is greater than the first length.

As embodied herein, the cellulose fiber layer can include modified cellulose fibers. In certain embodiments, the cellulose fiber layer can further include bicomponent fibers in amount ranging from about 5 wt-% to about 50 wt-% of the cellulose fiber layer. For example and not limitation, the bicomponent fibers in the cellulose fiber layer can include a PET core with a polyethylene sheath and have a dtex of at least about 1.5 dtex. In certain embodiments, the air filtration medium can include a binder on an external surface of the cellulose fiber layer. For example, the binder can be applied in an amount of from about 3 gsm to about 8 gsm.

In certain embodiments, the air filtration medium can include a second synthetic fiber layer, disposed between the first synthetic fiber layer and the cellulose fiber layer, having an FNI that is less than the FNI of the first synthetic fiber layer, but greater than the FNI of the cellulose fiber layer. The FNI of the second synthetic fiber layer can range from about 100 ft/(min %) to about 300 ft/(min %). For example, the dtex of the fibers in the second synthetic fiber layer can be less than the dtex of the fibers in the first synthetic fiber layer. In certain embodiments, the second synthetic fiber layer can include a blend of cellulose fibers and bicomponent fibers. In certain embodiments, the air filtration medium can include a fire suppression layer disposed adjacent to an outer surface of the cellulose fiber layer and comprising fire retardant fibers.

The present disclosure further provides an air filter comprising a filter housing and an air filtration medium comprising a first bicomponent fiber layer comprising fibers having a dtex of no more than about 5.7 dtex, wherein the first bicomponent fiber layer has a basis weight of from about 5 gsm to about 15 gsm; and a cellulose fiber layer having a basis weight of from about 25 gsm to about 100 gsm.

For example and not limitation, the air filter can have an estimated minimum efficiency reporting value (MERV) of from about 7 to about 9, when tested according to the ASHRAE 52.2 Test Standard. The air filter can create an initial pressure drop of from about 0.17″WG to about 0.32″WG, when measured according to the ASHRAE 52.2 Test Standard. When stored in a water bath or conditioning solution, the air filtration medium can have no observable mold after a time period of at least 2 weeks. Additionally or alternatively, when placed in a water bath, the air filtration medium can resist full saturation for at least about 5 minutes.

The foregoing has outlined broadly the features and technical advantages of the present application in order that the detailed description that follows can be better understood. Additional features and advantages of the application will be described hereinafter which form the subject of the claims of the application. It should be appreciated by those skilled in the art that the conception and specific embodiment disclosed can be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 5. BRIEF DESCRIPTION OF THE DRAWINGS

FIG. 1 provides a comparison of the initial removal efficiency in E3 and initial pressure drop of Samples 3A, 3C, and 3D in accordance with Example 3 of the present disclosure.

FIG. 2 provides an illustration of the initial removal efficiency in channels 1-12 for Samples 3A-3D and the Control Sample in accordance with Example 3 of the present disclosure.

FIG. 3 provides a comparison of the initial removal efficiency in E1, E2, and E3 of Samples 4F and 4FF in accordance with Example 4 of the present disclosure.

FIG. 4 provides a comparison of the initial removal efficiency in E1, E2, and E3 of Samples 4D, 4F, and 4H in accordance with Example 4 of the present disclosure.

FIG. 5 provides a comparison of the initial pressure drop and initial removal efficiency in E3 of Samples 4D, 4F, and 4H in accordance with Example 4 of the present disclosure.

FIGS. 6A-6E are photographs of the water uptake of Samples 4B-4D, when placed in a water bath in accordance with Example 4 of the present disclosure. FIG. 6A corresponds to Sample C (GI-4725 MBAL). FIG. 6B corresponds to Sample D (FFLE+ MBAL). FIG. 6C corresponds to Sample B (FFLE+ TBAL). FIG. 6D corresponds to Sample D (FFLE+ MBAL). FIG. 6E corresponds to Sample B (FFLE+ TBAL).

FIG. 7 provides a comparison of the initial pressure drop and initial removal efficiency in E3 of Samples 5B, 5C, 5D, and 5F in accordance with Example 5 of the present disclosure.

FIG. 8 provides a comparison of the initial pressure drop and initial removal efficiency in E1, E2, and E3 of Samples 5A and 5E in accordance with Example 5 of the present disclosure.

FIG. 9 provides a comparison of the initial pressure drop and initial removal efficiency in E3 of Samples 6A-6D in accordance with Example 6 of the present disclosure.

FIG. 10 provides the correlation between initial removal efficiency in E3 and average fiber volume for a center, cellulose fiber layer in accordance with Example 7 of the present disclosure.

FIG. 11 provides the correlation between initial removal efficiency in E3 and average fiber volume for a bottom, cellulose fiber layer in accordance with Example 7 of the present disclosure.

FIG. 12 illustrates the orientation of a fire suppression layer in an air filtration medium in accordance with one embodiment of the presently disclosed subject matter.

FIG. 13 provides a comparison of the initial pressure drop and initial removal efficiency in E3 of Samples in accordance with Example 13 of the present disclosure.

FIG. 14 provides an illustration of % Capture over particle size channel for Samples in accordance with Example 13 of the present disclosure.

FIG. 15 provides an illustration of the fiber volume present in the bottom cellulosic layer of each Sample in accordance with Example 13 of the present disclosure.

FIG. 16 provides an illustration of bottom layer distribution by fiber size for Samples in accordance with Example 13 of the present disclosure.

FIG. 17 provides a comparison of the initial pressure drop and initial removal efficiency in E3 of Samples in accordance with Example 17 of the present disclosure.

FIG. 18 provides a comparison the % particle capture of each channel in the three TBAL Samples in accordance with Example 17 of the present disclosure.

FIG. 19 provides a comparison of the % particle capture of each channel in the Samples in accordance with Example 17 of the present disclosure.

FIG. 20 provides a comparison of the initial pressure drop and initial removal efficiency in E3 of Samples in accordance with Example 18 of the present disclosure.

FIG. 21 provides a comparison the % particle capture of each channel in Samples in accordance with Example 18 of the present disclosure.

### 6. DETAILED DESCRIPTION

The presently disclosed subject matter provides air filtration media, which can be used in air filters for a variety of applications. The presently disclosed subject matter also provides methods for making such materials. These and other aspects of the disclosed subject matter are discussed more in the detailed description and examples.

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, alternatively or preferably up to 10%, alternatively or more preferably up to 5%, and alternatively or more preferably still up to 1% of a given value. Alternatively, particularly with respect to systems or processes, the term can mean within an order of magnitude, preferably within 5-fold, and alternatively or more preferably within 2-fold, of a value.

As used herein, the term “weight percent” is meant to refer to either (i) the quantity by weight of a constituent/component in the material as a percentage of the weight of a layer of the material; or (ii) to the quantity by weight of a constituent/component in the material as a percentage of the weight of the final nonwoven material or product.

The term “basis weight” as used herein refers to the quantity by weight of a compound over a given area. Examples of the units of measure include grams per square meter as identified by the acronym “gsm”.

As used herein, a “nonwoven” refers to a class of material, including but not limited to textiles or plastics. Nonwovens are sheet or web structures made of fiber, filaments, molten plastic, or plastic films bonded together mechanically, thermally, or chemically. A nonwoven is a fabric made directly from a web of fiber, without the yarn preparation necessary for weaving or knitting. In a nonwoven, the assembly of fibers is held together by one or more of the following: (1) by mechanical interlocking in a random web or mat; (2) by fusing of the fibers, as in the case of thermoplastic fibers; or (3) by bonding with a cementing medium such as a natural or synthetic resin.

As used herein, the term “cellulose” or “cellulosic” includes any material having cellulose as a major constituent, and specifically, comprising at least 50 percent by weight cellulose or a cellulose derivative. Thus, the term includes cotton, typical wood pulps, cellulose acetate, rayon, thermochemical wood pulp, chemical wood pulp, debonded chemical wood pulp, milkweed floss, microcrystalline cellulose, microfibrillated cellulose, and the like.

As used herein, the term “fiber” or “fibrous” refers to a particulate material wherein the length to diameter ratio of such particulate material is greater than about 10. Conversely, a “nonfiber” or “nonfibrous” material is meant to refer to a particulate material wherein the length to diameter ratio of such particulate matter is about 10 or less.

As used herein, the phrase “chemically modified,” when used in reference to a fiber, means that the fiber has been treated with a polyvalent metal-containing compound to produce a fiber with a polyvalent metal-containing compound bound to it. It is not necessary that the compound chemically bond with the fibers, although it is preferred that the compound remain associated in close proximity with the fibers, by coating, adhering, precipitation, or any other mechanism such that it is not dislodged from the fibers during normal handling of the fibers. In particular, the compound can remain associated with the fibers even when wetted or washed with a liquid. For convenience, the association between the fiber and the compound can be referred to as the bond, and the compound can be said to be bound to the fiber.

As used herein, the term “anti-microbial” refers to a property of reducing or eliminating the presence of microbes, including bacteria, viruses, and fungi.

As used herein, the term “mold resistant” when used in reference to a material means that no observable mold appears on the material within a certain time period. “No observable mold” means that no mold appears that is visible to the naked eye. For purpose of example, and not limitation, suitable procedures for evaluating mold resistances are described in the “USP <51> Preservative Challenge Test for Personal Care Products,” available at http://microchemlab.com/test/usp-preservative-challenge-test-personal-care-products and the “Modified Kirby Bauer Method,” available at d/Jwho01e/4.10.6.html.

As used herein, the term “fire retardant” when used in reference to a material means that, when the material is exposed to a flame, the speed of flame spread during combustion is decreased as compared to similar materials that are not fire retardant. Fire retardant materials can also have increased resistance to burning, e.g., they can require a hotter flame or longer exposure time prior to combustion.

As used herein, the phrase “high core bicomponent fibers” refers to bicomponent fibers having a core-sheath configuration, wherein the core comprises more than 50% of the fiber, by volume. Equivalently stated, it can be said that high core bicomponent fibers have a core to sheath ratio of greater than 1:1.

### Fibers

The air filtration medium of the presently disclosed subject matter comprises fibers. The fibers can be natural, synthetic, or a mixture thereof. In one embodiment, the fibers can be cellulose-based fibers, one or more synthetic fibers, or a mixture thereof.

### Cellulose Fibers

Any cellulose fibers known in the art, including cellulose fibers of any natural origin, such as those derived from wood pulp or regenerated cellulose, can be used in a cellulose fiber layer. In certain embodiment, cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. In other embodiments, cellulose fibers include, but are not limited to, kraft digested fibers, including prehydrolyzed kraft digested fibers. Non-limiting examples of cellulose fibers suitable for use in this subject matter are the cellulose fibers derived from softwoods, such as pines, firs, and spruces. Other suitable cellulose fibers include, but are not limited to, those derived from Esparto grass, bagasse, kemp, flax, hemp, kenaf, and other lignaceous and cellulosic fiber sources. Suitable cellulose fibers include, but are not limited to, bleached Kraft southern pine fibers sold under the trademark FOLEY FLUFFS® (available from GP Cellulose).

The air filtration medium of the disclosed subject matter can also include, but is not limited to, a commercially available bright fluff pulp including, but not limited to, southern softwood fluff pulp (such as Treated FOLEY FLUFFS® or Golden Isles® 4723 or Golden Isles® 4725 from GP Cellulose), northern softwood sulfite pulp (such as T 730 from Weyerhaeuser), or hardwood pulp (such as eucalyptus). While certain pulps can be preferred based on a variety of factors, any cellulosic fluff pulp or mixtures thereof can be used. In certain embodiments, wood cellulose, cotton linter pulp, chemically modified cellulose such as crosslinked cellulose fibers and highly purified cellulose fibers can be used. Non-limiting examples of additional pulps are FOLEY FLUFFS® FFTAS (also known as FFTAS or GP Cellulose FFT-AS pulp), and Weyco CF401.

### Chemically Modified Cellulose Fibers

The presently disclosed subject matter contemplates the use of cellulose-based fibers that are chemically modified. As embodied herein, the cellulose fibers can be chemically treated with a compound comprising a polyvalent metal ion, e.g., a polyvalent cation. Such chemically modified fibers are described, for the purpose of illustration and not limitation, in U.S. Pat. Nos. 6,562,743 and 8,946,100, the contents of which are hereby incorporated by reference in their entireties. The chemically modified cellulose fibers can optionally be associated with a weak acid. For example, suitable modified cellulose fibers include aluminum-modified FFLE+ fibers from GP Cellulose.

The chemically modified cellulose fiber can be treated with from about 0.1 weight percent to about 20 weight percent of the polyvalent cation-containing compound, based on the dry weight of the untreated fiber, desirably with from about 2 weight percent to about 12 weight percent of the polyvalent metal-containing compound, and alternatively with from about 3 weight percent to about 8 weight percent of the polyvalent cation-containing compound, based on the dry weight of the untreated fiber.

Any polyvalent metal salt including transition metal salts can be used, provided that the compound is capable of increasing the stability of the cellulose fiber in an alkaline environment. Examples of suitable polyvalent metals include beryllium, magnesium, calcium, strontium, barium, titanium, zirconium, vanadium, chromium, molybdenum, tungsten, manganese, iron, cobalt, nickel, copper, zinc, aluminum and tin. In particular embodiment, the ions are selected from the group including aluminum, iron and tin. In particular embodiments, the metal ions have oxidation states of +3 or +4. In certain embodiments, the polyvalent metal is aluminum. Any salt containing the polyvalent metal ion can be employed. Examples of suitable inorganic salts of the above metals include chlorides, nitrates, sulfates, borates, bromides, iodides, fluorides, nitrides, perchlorates, phosphates, hydroxides, sulfides, carbonates, bicarbonates, oxides, alkoxides phenoxides, phosphites, and hypophosphites. Examples of suitable organic salts of the above metals include formates, acetates, butyrates, hexanoates, adipates, citrates, lactates, oxalates, propionates, salicylates, glycinates, tartrates, glycolates, sulfonates, phosphonates, glutamates, octanoates, benzoates, gluconates, maleates, succinates, and 4,5-dihydroxy-benzene-1,3-disulfonates. In addition to the polyvalent metal salts, other compounds such as complexes of the above salts include amines, ethylenediaminetetra-acetic acid (EDTA), diethylenetriaminepenta-acetic acid (DIPA), nitrilotri-acetic acid (NTA), 2,4-pentanedione, and ammonia can be used. In certain embodiments, the polyvalent metal salt is aluminum chloride, aluminum hydroxide, or aluminum sulfate. Alum is an aluminum sulfate salt which is soluble in water. In an aqueous slurry of cellulose, some of the alum will penetrate the fiber cell wall, but since the concentration of ions is low, most of the dissolved aluminum salt will be outside the fiber. When the pH is adjusted to precipitate aluminum hydroxide, most of the precipitate adheres to the fiber surface.

In certain embodiments, the chemically modified cellulose fiber has an acid bound or otherwise associated with it. A variety of suitable acids can be employed, although the acid preferably should have a low volatility. In certain embodiments, the acid is a weak acid.

For example, and not limitation, suitable acids include inorganic acids such as sodium bisulfate, sodium dihydrogen phosphate and disodium hydrogen phosphate, and organic acids such as formic, acetic, aspartic, propionic, butyric, hexanoic, benzoic, gluconic, oxalic, malonic, succinic, glutaric, tartaric, maleic, malic, phthallic, sulfonic, phosphonic, salicylic, glycolic, citric, butanetetracarboxylic acid (BTCA), octanoic, polyacrylic, polysulfonic, polymaleic, and lignosulfonic acids, as well as hydrolyzed-polyacrylamide and CMC (carboxymethylcellulose). Among the carboxylic acids, acids with two carboxyl groups are preferred, and acids with three carboxyl groups are alternatives. In certain embodiments, the acid is citric acid.

In general, the amount of acid employed can depend on the acidity and the molecular weight of the acid. In certain embodiments, the acid comprises from about 0.5 weight percent of the fibers to about 10 weight percent of the fibers. As used herein, the “weight percent of the fibers” refers to the weight percent of dry fiber treated with the polyvalent metal containing compound, i.e., based on the dry weight of the treated fibers. For example, in certain embodiments, the acid is citric acid in an amount of from about 0.5 weight percent to about 3 weight percent of the fibers. A particular combination is an aluminum-containing compound and citric acid. For the chemically treated fibers of this aspect of this disclosed subject matter, it is desirable that the weak acid content of the chemically treated fibers is from about 0.5 weight percent to about 10 weight percent based on the dry weight of the treated fibers, more desirably, from about 0.5 weight percent to about 5 weight percent based on the dry weight of the treated fibers, and, alternatively, from about 0.5 weight percent to about 3 weight percent based on the dry weight of the treated fibers.

Alternatively, in certain embodiments, a buffer salt can be used instead of a weak acid in combination with the polyvalent metal-containing compound. Any buffer salt that in water would provide a solution having a pH of less than about 7 is suitable. For example, and not limitation, suitable buffer salts include sodium acetate, sodium oxalate, sodium tartrate, sodium phthalate, sodium dihydrogen phosphate, disodium hydrogen phosphate and sodium borate. Buffer salts can be used in combination with their acids in a combination that in water would provide a solution having a pH of less than about 7, for example, oxalic acid/sodium oxalate, tartaric acid/sodium tartrate, sodium phthalate/phthalic acid, and sodium dihydrogen phosphate/disodium hydrogen phosphate.

In further variations, the polyvalent metal-containing compound can be used in combination with an insoluble metal hydroxide, such as, for example, magnesium hydroxide, or in combination with one or more alkali stable anti-oxidant chemicals or alkali stable reducing agents that would inhibit fiber degradation in an alkaline oxygen environment. Examples include inorganic chemicals such as sodium sulfite, and organic chemicals such as hydroquinone.

For the chemically modified cellulose fibers, it is desirable that the buffer salt content, the buffer salt weak acid combination content, the insoluble metal hydroxide content and/or the antioxidant content of the chemically treated fibers is from about 0.5 weight percent to about 10 weight percent based on the dry weight of the treated fibers, more desirably, from about 0.5 weight percent to about 5 weight percent based on the dry weight of the treated fibers, and, alternatively, from about 0.5 weight percent to about 3 weight percent based on the dry weight of the treated fibers.

In certain embodiments, reducing agents can be applied to the modified cellulose fibers to maintain desired levels of fiber brightness, by reducing brightness reversion. The addition of acidic substances can cause browning of fibers when heated during processing of webs containing the fibers. Reducing agents counter the browning of the fibers. The reducing agent can also bond to the fibers. Suitable reducing agents include sodium hypophosphite, sodium bisulfite, and mixtures thereof.

The fibers suitable for use in the practice of the disclosed subject matter can be treated in a variety of ways to provide the polyvalent metal ion-containing compound in close association with the fibers. One method is to introduce the compound in solution with the fibers in slurry form and cause the compound to precipitate onto the surface of the fibers. Alternatively, the fibers can be sprayed with the compound in aqueous or non-aqueous solution or suspension. The fibers can be treated while in an individualized state, or in the form of a web. For example, the compound can be applied directly onto the fibers in powder or other physical form. Whatever method is used, however, it is preferred that the compound remain bound to the fibers, such that the compound is not dislodged during normal physical handling of the fiber before contact of the fiber with liquid.

In a specific embodiment, the treated fibers of the presently disclosed subject matter are made from cellulose fiber known as FOLEY FLUFFS® from GP Cellulose. The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and, optionally, sprayed with a solution of citric acid at a loading of about 2.5 weight percent of the fibers. The web is then packaged and shipped to end users for further processing, including fiberization to form individualized fibers useful in the manufacture of various products.

In an alternative embodiment, the treated fibers of the presently disclosed subject matter are made from cellulose fiber obtained from GP Cellulose. The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and sprayed with a solution of sodium oleate at a loading of about 1.0 weight percent of the fibers. The web is then packaged and shipped to end users for further processing, including re-slurrying to form a web useful in the manufacture of filtration products. If a reducing agent is to be applied, preferably it is applied before a drying step and following any other application steps. The reducing agent can be applied by spraying, painting or foaming.

Metal ion content, including aluminum or iron content, in pulp samples can be determined by wet ashing (oxidizing) the sample with nitric and perchloric acids in a digestion apparatus. A blank is oxidized and carried through the same steps as the sample. The sample is then analyzed using an inductively coupled plasma spectrophotometer, such as, for example, a Perkin-Elmer ICP 6500. From the analysis, the ion content in the sample can be determined in parts per million. The polyvalent cation content desirably is from about 0.1 weight percent to about 5.0 weight percent, based on the dry weight of the treated fibers, more desirably, from about 0.1 weight percent to about 3.0 weight percent, based on the dry weight of the treated fibers, alternatively from about 0.1 weight percent to about 1.5 weight percent, based on the dry weight of the treated fibers, or alternatively, from about 0.2 weight percent to about 0.9 weight percent, based on the dry weight of the treated fibers, and alternatively from about 0.3 weight percent to about 0.8 weight percent, based on the dry weight of the treated fibers.

Without intending to be bound by theory, it is believed that by this process, the soluble Al₂(SO₄)₃ introduced to the pulp slurry is converted to insoluble Al(OH)₃ as the pH is increased. The insoluble aluminum hydroxide precipitates onto the fiber. Thus, the resultant chemically treated cellulose fibers are coated with Al(OH)₃ or contain the insoluble metal within the fiber interior.

The sodium oleate sprayed onto the web containing the fibers dries on the fibers. When the Al(OH)₃-oleate treated fibers are formed into a filter-based sheet, the aluminum and oleate ions create a hydrophobic environment in addition to increasing the wet strength of the structure. These results are exemplified in the procedures set forth below.

In another embodiment, hydrated aluminum sulfate and sodium oleate are sprayed on the fiber after the drying section of a paper machine. In another embodiment, hydrated aluminum sulfate and sodium oleate are precipitated onto the fiber in the wet end section of a paper machine. In another embodiment, hydrated aluminum sulfate and sodium hypophosphite are sprayed on the fiber prior to the pressing stage, and sodium oleate is sprayed after drying. In another embodiment, hydrated aluminum sulfate, sodium hypophosphite and sodium oleate are sprayed on the fiber prior to the pressing stage. In yet another embodiment, hydrated aluminum sulfate is precipitated onto the fiber, hydrated aluminum and sodium hypophosphite are sprayed on the fiber prior to pressing, and sodium oleate is sprayed on the fiber after drying. In another embodiment, hydrated aluminum sulfate is precipitated onto the fiber and sodium oleate is sprayed on the fiber prior to the pressing stage.

Various materials, structures and manufacturing processes can be used in connection with the presently disclosed modified cellulose fibers, for example and not limitation, as described in U.S. Pat. Nos. 6,241,713, 6,353,148, 6,353,148, 6,171,441, 6,159,335, 5,695,486, 6,344,109, 5,068,079, 5,492,759, 5,269,049, 5,601,921, 5,693,162, 5,922,163, 6,007,653, 6,355,079, 6,403,857, 6,479,415, 6,562,742, 6,562,743, 6,559,081, 6,495,734, 6,420,626, and 8,946,100, and in U.S. Patent Publication Nos. US2004/0208175 and US2002/0013560, all of which are hereby incorporated by reference in their entireties.

In certain embodiments, chemically modified cellulose such as cross-linked cellulose fibers and highly purified cellulose fibers can be used. In particular embodiments, the modified cellulose fibers are crosslinked cellulose fibers. In certain embodiments, the modified cellulose fibers comprise a polyhydroxy compound. Non-limiting examples of polyhydroxy compounds include glycerol, trimethylolpropane, pentaerythritol, polyvinyl alcohol, partially hydrolyzed polyvinyl acetate, and fully hydrolyzed polyvinyl acetate.

In certain embodiments, the modified cellulose pulp fibers have been softened or plasticized to be inherently more compressible than unmodified pulp fibers. The same pressure applied to a plasticized pulp web will result in higher density than when applied to an unmodified pulp web. Additionally, the densified web of plasticized cellulose fibers is inherently softer than a similar density web of unmodified fiber of the same wood type. Softwood pulps can be made more compressible using cationic surfactants as debonders to disrupt interfiber associations. Use of one or more debonders facilitates the disintegration of the pulp sheet into fluff in the airlaid process. Examples of debonders include, but are not limited to, those disclosed in U.S. Pat. Nos. 4,432,833, 4,425,186 and 5,776,308, all of which are hereby incorporated by reference in their entireties. One example of a debonder-treated cellulose pulp is FFLE+. Plasticizers for cellulose, which can be added to a pulp slurry prior to forming wetlaid sheets, can also be used to soften pulp, although they act by a different mechanism than debonding agents. Plasticizing agents act within the fiber, at the cellulose molecule, to make flexible or soften amorphous regions. The resulting fibers are characterized as limp. Since the plasticized fibers lack stiffness, the comminuted pulp is easier to densify compared to fibers not treated with plasticizers. Plasticizers include, but are not limited to, polyhydric alcohols such as glycerol, low molecular weight polyglycol such as polyethylene glycols, and polyhydroxy compounds. These and other plasticizers are described and exemplified in U.S. Pat. Nos. 4,098,996, 5,547,541 and 4,731,269, all of which are hereby incorporated by reference in their entireties. Ammonia, urea, and alkylamines are also known to plasticize wood products, which mainly contain cellulose (A. J. Stamm, Forest Products Journal 5(6):413, 1955, hereby incorporated by reference in its entirety).

### Bicomponent Fibers

In addition to the use of cellulose fibers, the presently disclosed subject matter also contemplates the use of synthetic fibers, such as bicomponent fibers. Bicomponent fibers having a core and sheath are known in the art. Many varieties are used in the manufacture of nonwoven materials, particularly those produced for use in airlaid techniques. Various bicomponent fibers suitable for use in the presently disclosed subject matter are disclosed in U.S. Pat. Nos. 5,372,885 and 5,456,982, both of which are hereby incorporated by reference in their entireties. Examples of bicomponent fiber manufacturers include, but are not limited to, Trevira (Bobingen, Germany), Fiber Innovation Technologies (Johnson City, Tenn.) and ES Fiber Visions (Athens, Ga.).

Bicomponent fibers can incorporate a variety of polymers as their core and sheath components. Bicomponent fibers that have a PE (polyethylene) or modified PE sheath typically have a PET (polyethylene terephthalate) or PP (polypropylene) core. In one embodiment, the bicomponent fibers have a core made of polypropylene and a sheath made of polyethylene. Alternatively or additionally, the bicomponent fibers can have a core made of polyester (e.g., PET) and a sheath made of polyethylene.

As embodied herein, the bicomponent fiber can be low staple fibers having a dtex from about 1.0 dtex to about 10.0 dtex, and alternatively no more than about 5.7 dtex. For example, the dtex of the bicomponent fiber can be about 1.7 dtex, about 2.0 dtex, about 2.2 dtex, about 3.0 dtex, about 3.3 dtex, about 5.0 dtex, or about 5.7 dtex. The length of the bicomponent fiber can be from about 3 mm to about 36 mm, alternatively from about 3 mm to about 12 mm, alternatively from about 3 mm to about 10, alternatively from about 4 mm to about 8 mm. In particular embodiments, the length of the bicomponent fiber is from about 4 mm to about 6 mm, or about 4 mm, or about 6 mm.

In a particular embodiment, the bicomponent fiber is Trevira-257, which contains a polypropylene core and a polyethylene sheath in an eccentric or a concentric configuration. Trevira-257 has been produced in a variety of dtex and cut lengths. Specific configurations can have a dtex of no more than about 5.7 dtex, for example, about 1.7 dtex, about 2.2 dtex, about 3.3 dtex, or about 5.7 dtex, and a cut length of about 4 mm to about 6 mm, for example about 4 mm or about 6 mm. In another specific embodiment, the bicomponent fiber contains a PET core and a polyethylene sheath in an eccentric configuration. Alternative configurations can have a dtex of no more than about 5.7 dtex, for example, about 2.0 dtex, about 3.0 dtex, or about 5.0 dtex, and a cut length of about 4 mm to about 6 mm, for example about 4 mm or about 6 mm. Additionally or alternatively, in certain embodiments, a high core bicomponent fiber can be used having a high core to sheath ratio that exceeds 1:1, i.e., the high core bicomponent fibers comprise more than 50% core by volume. As embodied herein, the high core bicomponent fibers can have a polyethylene sheath. The core of the high core bicomponent fibers can be made from a polymer with a melting point greater than about 200° C. and higher density than the polyethylene sheath. For example and not limitation, suitable core polymers include high melt point polyesters, such as poly(ethylene terephthalate) (PET). The core to sheath ratio of the high core bicomponent fibers can range from about 1:1 to about 2.5:1, or from about 1:1 to about 7:3, or from about 1.5:1 to about 7:3, or about 7:3. In particular embodiments, such a high core bicomponent fiber can have a dtex of about 1.7 dtex and a cut length of about 6 mm, although a person of skill in the art will appreciate that the bicomponent fiber can be formed with other thicknesses and cut lengths. Alternatively, a bicomponent fiber having a PET core and a polyethylene sheath can be Trevira-1661, for example, having a concentric configuration, a dtex of about 2.2 dtex, and a cut length of about 6 mm.

Bicomponent fibers are typically fabricated commercially by melt spinning. In this procedure, each molten polymer is extruded through a die, for example, a spinneret, with subsequent pulling of the molten polymer to move it away from the face of the spinneret. This is followed by solidification of the polymer by heat transfer to a surrounding fluid medium, for example chilled air, and taking up of the now solid filament. Non-limiting examples of additional steps after melt spinning can also include hot or cold drawing, heat treating, crimping and cutting. This overall manufacturing process is generally carried out as a discontinuous two-step process that first involves spinning of the filaments and their collection into a tow that comprises numerous filaments. During the spinning step, when molten polymer is pulled away from the face of the spinneret, some drawing of the filament does occur which can also be called the draw-down. This is followed by a second step where the spun fibers are drawn or stretched to increase molecular alignment and crystallinity and to give enhanced strength and other physical properties to the individual filaments. Subsequent steps can include, but are not limited to, heat setting, crimping and cutting of the filament into fibers. The drawing or stretching step can involve drawing the core of the bicomponent fiber, the sheath of the bicomponent fiber or both the core and the sheath of the bicomponent fiber depending on the materials from which the core and sheath are comprised as well as the conditions employed during the drawing or stretching process.

Bicomponent fibers can also be formed in a continuous process where the spinning and drawing are done in a continuous process. During the fiber manufacturing process, it is desirable to add various materials to the fiber after the melt spinning step at various subsequent steps in the process. These materials can be referred to as “finish” and be comprised of active agents such as, but not limited to, lubricants and anti-static agents. The finish is typically delivered via an aqueous based solution or emulsion. Finishes can provide desirable properties for both the manufacturing of the bicomponent fiber and for the user of the fiber, for example in an airlaid or wetlaid process.

Numerous other processes are involved before, during and after the spinning and drawing steps and are disclosed in U.S. Pat. Nos. 4,950,541, 5,082,899, 5,126,199, 5,372,885, 5,456,982, 5,705,565, 2,861,319, 2,931,091, 2,989,798, 3,038,235, 3,081,490, 3,117,362, 3,121,254, 3,188,689, 3,237,245, 3,249,669, 3,457,342, 3,466,703, 3,469,279, 3,500,498, 3,585,685, 3,163,170, 3,692,423, 3,716,317, 3,778,208, 3,787,162, 3,814,561, 3,963,406, 3,992,499, 4,052,146, 4,251,200, 4,350,006, 4,370,114, 4,406,850, 4,445,833, 4,717,325, 4,743,189, 5,162,074, 5,256,050, 5,505,889, 5,582,913, and 6,670,035, all of which are hereby incorporated by reference in their entireties.

The presently disclosed subject matter can also include, but are not limited to, articles that contain bicomponent fibers that are partially drawn with varying degrees of draw or stretch, highly drawn bicomponent fibers and mixtures thereof. These can include, but are not limited to, a highly drawn polyester core bicomponent fiber with a variety of sheath materials, specifically including a polyethylene sheath such as Trevira-255 (Varde, Denmark) or a highly drawn polypropylene core bicomponent fiber with a variety of sheath materials, specifically including a polyethylene sheath such as ES FiberVisions AL-Adhesion-C(Varde, Denmark). Additionally, Trevira T265 bicomponent fiber (Varde, Denmark), having a partially drawn core with a core made of polybutylene terephthalate (PBT) and a sheath made of polyethylene can be used. The use of both partially drawn and highly drawn bicomponent fibers in the same structure can be leveraged to meet specific physical and performance properties based on how they are incorporated into the structure.

The bicomponent fibers of the presently disclosed subject matter are not limited in scope to any specific polymers for either the core or the sheath as any partially drawn core bicomponent fiber can provide enhanced performance regarding elongation and strength. The degree to which the partially drawn bicomponent fibers are drawn is not limited in scope as different degrees of drawing will yield different enhancements in performance. The scope of the partially drawn bicomponent fibers encompasses fibers with various core sheath configurations including, but not limited to concentric, eccentric, side by side, islands in a sea, pie segments and other variations. The relative weight percentages of the core and sheath components of the total fiber can be varied. In addition, the scope of this subject matter covers the use of partially drawn homopolymers such as polyester, polypropylene, nylon, and other melt spinnable polymers. The scope of this subject matter also covers multicomponent fibers that can have more than two polymers as part of the fiber structure.

### Other Synthetic Fibers

Other synthetic fibers suitable for use in various embodiments as fibers or as bicomponent binder fibers include, but are not limited to, fibers made from various polymers including, by way of example and not by limitation, acrylic, polyamides (including, but not limited to, Nylon 6, Nylon 6/6, Nylon 12, polyaspartic acid, polyglutamic acid), polyamines, polyimides, polyacrylics (including, but not limited to, polyacrylamide, polyacrylonitrile, esters of methacrylic acid and acrylic acid), polycarbonates (including, but not limited to, polybisphenol A carbonate, polypropylene carbonate), polydienes (including, but not limited to, polybutadiene, polyisoprene, polynorbomene), polyepoxides, polyesters (including, but not limited to, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate), polyethers (including, but not limited to, polyethylene glycol (polyethylene oxide), polybutylene glycol, polypropylene oxide, polyoxymethylene (paraformaldehyde), polytetramethylene ether (polytetrahydrofuran), polyepichlorohydrin), polyfluorocarbons, formaldehyde polymers (including, but not limited to, urea-formaldehyde, melamine-formaldehyde, phenol formaldehyde), natural polymers (including, but not limited to, cellulosics, chitosans, lignins, waxes), polyolefins (including, but not limited to, polyethylene, polypropylene, polybutylene, polybutene, polyoctene), polyphenylenes (including, but not limited to, polyphenylene oxide, polyphenylene sulfide, polyphenylene ether sulfone), silicon containing polymers (including, but not limited to, polydimethyl siloxane, polycarbomethyl silane), polyurethanes, polyvinyls (including, but not limited to, polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone), polyacetals, polyarylates, and copolymers (including, but not limited to, polyethylene-co-vinyl acetate, polyethylene-co-acrylic acid, polybutylene terephthalate-co-polyethylene terephthalate, polylauryllactam-block-polytetrahydrofuran), polybutylene succinate and polylactic acid based polymers.

In particular embodiments, polyester (PET) fibers such as Trevira-245, are used in a synthetic fiber layer. For example, and not limitation, the synthetic fiber layer can contain a high dtex staple fibers in the range of about 5 to about 20 dtex. In certain embodiments, the dtex value can range from about 5 dtex to about 15 dtex, or from about 5 dtex to about 10 dtex. In particular embodiments, the fiber can have a dtex value of about 6.7 dtex.

### Additional Fiber Types

The air filtration media of the present disclosure can optionally include other types of fibers, as known in the art. For example, these additional fiber types can be included in a separate fiber layer or blended with cellulose and/or synthetic fibers in a cellulose or synthetic fiber layer.

For example, in certain embodiments, the air filtration media can include mercerized fibers. As embodied herein, the mercerized fibers can he mercerized cellulose fibers, for example and not limitation, high quality mercerized, curly southern pine pulps such as HPZ or HPZ-XS (GP Cellulose). For example, and as embodied herein, mercerized fibers can have an increased curl that can increase their surface area and increase the permeability and pore size of a material made with such mercerized fibers.

Mercerized fibers are generally prepared by the chemical treatment of cellulose fibers, e.g., using a caustic solution, to alter the morphology of the fiber structure. Upon mercerization, cellulose fibers generally have increased curl and kink. Mercerization can convert cellulose from its native form to a more thermodynamically stable form through a low consistency or high consistency process. For example and not limitation, suitable methods of mercerization are provided in Rydholm, ed. Pulping Processes (Interscience Publishers, 1965) and Ott, Spurlin and Grafflin, eds., Cellulose and Cellulose Derivatives, Vol. v, Part 1 (Interscience Publishers, 1954), and in U.S. Patent Publication No. US20160032494A1, the contents of which are hereby incorporated by reference in their entireties.

For further example, in certain embodiments, the air filtration media can include treated Golden Isles CO™ pulp, such as Golden Isles CO™ 4855, Golden Isles CO™ 4757, Golden Isles CO™ 4865 or Golden Isles CO™ 4875 (from GP Cellulose). For example, the Golden Isles CO™ pulp can be a semi-treated or fully-treated pulp. Golden Isles CO™ pulp has been shown to exhibit both odor control and some anti-bacterial activity, as described for example and not limitation in U.S. Pat. No. 9,512,237, the contents of which are hereby incorporated by reference in their entirety. As used herein, Golden Isles® pulp is referenced by number in some instances. For example, GI-4725 is used to denote Golden Isles® pulp 4725.

Additionally or alternatively, in certain embodiments, the air filtration medium can include one or more fire-retardant fibers. Fire-retardant properties can be imparted by chemical treatment of the fibers and/or by the molecular arrangement of the fibers. For example, and not limitation, suitable fire-retardant fibers include fire retardant polyester (e.g., PET fibers) that includes a phosphor-organic compound, such as Trevira-276 and Trevira-270. The use of fibers having a phosphor-organic compound can provide permanent fire-retardant properties, as compared to fibers that are only surface-treated. Moreover, the use of fibers that are inherently fire-retardant can eliminate the requirement and expense of additional chemical treatments. However, it is also possible to impart fire-retardant properties during processing, for example, by adding a fire-retardant coating to fibers before or after forming a nonwoven material.

### Binders

Suitable binders include, but are not limited to, liquid binders and powder binders. Non-limiting examples of liquid binders include emulsions, solutions, or suspensions of binders. Non-limiting examples of binders include polyethylene powders, copolymer binders, vinylacetate ethylene binders, styrene-butadiene binders, urethanes, urethane-based binders, acrylic binders, thermoplastic binders, natural polymer-based binders, and mixtures thereof.

Suitable binders include, but are not limited to, copolymers, including vinyl-chloride containing copolymers such as Wacker Vinnol 4500, Vinnol 4514, and Vinnol 4530, CE-35, vinylacetate ethylene (“VAE”) copolymers, which can have a stabilizer such as Wacker Vinnapas 192, Wacker Vinnapas EF 539, Wacker Vinnapas EP907, Wacker Vinnapas EP129, Celanese Duroset E130, Celanese Dur-O-Set Elite 130 25-1813 and Celanese Dur-O-Set TX-849, Celanese 75-524A, polyvinyl alcohol-polyvinyl acetate blends such as Wacker Vinac 911, vinyl acetate homopolyers, polyvinyl amines such as BASF Luredur, acrylics, cationic acrylamides, polyacryliamides such as Bercon Berstrength 5040 and Bercon Berstrength 5150, hydroxyethyl cellulose, starch such as National Starch CATO® 232, National Starch CATO® 255, National Starch Optibond, National Starch Optipro, or National Starch OptiPLUS, guar gum, styrene-butadienes, urethanes, urethane-based binders, thermoplastic binders, acrylic binders, and carboxymethyl cellulose such as Hercules Aqualon CMC. In certain embodiments, the binder is a natural polymer-based binder. Non-limiting examples of natural polymer-based binders include polymers derived from starch, cellulose, chitin, and other polysaccharides.

In certain embodiments, the binder is water-soluble. In one embodiment, the binder is a vinylacetate ethylene copolymer. One non-limiting example of such copolymers is EP907 (Wacker Chemicals, Munich, Germany). Vinnapas EP907 can be applied at a level of about 10% solids incorporating about 0.75% by weight Aerosol OT (Cytec Industries, West Paterson, N.J.), which is an anionic surfactant. Other classes of liquid binders such as styrene-butadiene and acrylic binders can also be used.

In certain embodiments, the binder is not water-soluble. Examples of these binders include, but are not limited to, Vinnapas 124 and 192 (Wacker), which can have an opacifier and whitener, including, but not limited to, titanium dioxide, dispersed in the emulsion. Other binders include, but are not limited to, Celanese Emulsions (Bridgewater, N.J.) Elite 22 and Elite 33.

In certain embodiments, the binder is a thermoplastic binder. Such thermoplastic binders include, but are not limited to, any thermoplastic polymer which can be melted at temperatures which will not extensively damage the cellulose fibers. In a specific embodiment, the melting point of the thermoplastic binding material will be less than about 175° C. Examples of suitable thermoplastic materials include, but are not limited to, suspensions of thermoplastic binders and thermoplastic powders. In particular embodiments, the thermoplastic binding material can be, for example, polyethylene, polypropylene, polyvinylchloride, and/or polyvinylidene chloride.

The binder can be non-crosslinkable or crosslinkable. In certain embodiments, the binder is WD4047 urethane-based binder solution supplied by HB Fuller. In one embodiment, the binder is Michem Prime 4983-45N dispersion of ethylene acrylic acid (“EAA”) copolymer supplied by Michelman. In certain embodiments, the binder is Dur-0-Set Elite 22LV emulsion of VAE binder supplied by Celanese Emulsions (Bridgewater, N.J.). As noted above, in particular embodiments, the binder is crosslinkable. It is also understood that crosslinkable binders are also known as permanent wet strength binders. A permanent wet-strength binder includes, but is not limited to, Kymene® (Hercules Inc., Wilmington, Del.), Parez® (American Cyanamid Company, Wayne, N.J.), Wacker Vinnapas or AF192 (Wacker Chemie AG, Munich, Germany), or the like. Various permanent wet-strength agents are described in U.S. Pat. Nos. 2,345,543, 2,926,116, and 2,926,154, the disclosures of which are incorporated by reference in their entirety. Other permanent wet-strength binders include, but are not limited to, polyamine-epichlorohydrin, polyamide epichlorohydrin or polyamide-amine epichlorohydrin resins, which are collectively termed “PAE resins”. Non-limiting exemplary permanent wet-strength binders include Kymene 557H or Kymene 557LX (Hercules Inc., Wilmington, Del.) and have been described in U.S. Pat. Nos. 3,700,623 and 3,772,076, which are incorporated herein in their entirety by reference thereto.

Alternatively, in certain embodiments, the binder is a temporary wet-strength binder. The temporary wet-strength binders include, but are not limited to, Hercobond® (Hercules Inc., Wilmington, Del.), Parez® 750 (American Cyanamid Company, Wayne, N.J.), Parez® 745 (American Cyanamid Company, Wayne, N.J.), or the like. Other suitable temporary wet-strength binders include, but are not limited to, dialdehyde starch, polyethylene imine, mannogalactan gum, glyoxal, and dialdehyde mannogalactan. Other suitable temporary wet-strength agents are described in U.S. Pat. Nos. 3,556,932, 5,466,337, 3,556,933, 4,605,702, 4,603,176, 5,935,383, and 6,017,417, all of which are incorporated herein in their entirety by reference thereto.

In certain embodiments, binders are applied as emulsions in amounts ranging from about 1 gsm to about 15 gsm, or from about 2 gsm to about 10 gsm, or from about 3 gsm to about 8 gsm. Binder can be applied to one side of a fibrous layer, preferably an externally facing layer. Alternatively, binder can be applied to both sides of a layer, in equal or disproportionate amounts.

### Air Filtration Medium

The presently disclosed subject matter provides for air filtration media with many advantages, including high filtration and initial removal efficiency. Moreover, the air filtration media includes a cellulose fiber layer, while being mold and moisture resistant. Additionally, the air filtration media can include a binder, which can impart both stiffening and fire-retardant properties. As embodied herein, the air filtration medium can include at least two layers, at least three layers, at least four layers, at least five layers, or at least six layers, wherein at least one layer is a synthetic fiber layer and at least one layer is a cellulose fiber layer.

In certain embodiments, the airlaid filtration medium comprises at least two layers, wherein each layer comprises a specific fibrous content. For example, the two layers can be a synthetic fiber layer and a cellulose fiber layer. The airlaid filtration medium can further include one or more additional layers, for example and not limitation, a second synthetic fiber layer and a third synthetic fiber layer.

Additionally, and as embodied herein, the fibers can be arranged directionally, with the synthetic fiber layer(s) nearest the air flow. Additionally, each layer can have a specific FNI, as explained in further detail below. Layers with higher FNI, i.e., synthetic fiber layers, can be arranged nearest to the airflow. Thus, in certain embodiments, the fiber types can be selected to create a directional density gradient through the air filtration medium, e.g., based on their composition, dtex, and/or fiber length. For example, the synthetic fiber layer nearest the air flow (e.g., nearest the top of the air filtration medium) can have a dtex that is the same as or greater than the dtex of additional synthetic fiber layers. Moreover, the density of the synthetic fiber layer(s) can be greater than that of the cellulose fiber layer(s). Alternatively, in certain embodiments, the air filtration medium can have multiple alternating gradients, created by alternating synthetic fiber layers with higher and lower FNIs.

In specific embodiments, the air filtration medium can be a two-layer nonwoven structure. The air filtration medium can contain a synthetic fiber layer and a cellulose fiber layer. In certain embodiments, the first synthetic fiber layer can contain bicomponent fibers having a dtex of no more than about 15 dtex. In certain embodiments, the bicomponent fibers can have a PET or polypropylene core with a polyethylene sheath. In certain embodiments, the bicomponent fibers can have an eccentric configuration. Alternatively or additionally, the bicomponent fibers can have a concentric configuration. In alternative embodiments, the synthetic fiber layer can include mono-component synthetic fibers, such as PET fibers. The PET fibers can have a higher dtex, e.g., from about 5 dtex to about 15 dtex. The first synthetic fiber layer can include two or more types of bicomponent fibers. For example, in certain embodiments, the first synthetic fiber layer can include at least two different bicomponent fibers that vary by fiber length, e.g., fibers having lengths of about 4 mm and about 6 mm.

In certain embodiments, the first synthetic fiber layer can have a basis weight of from about 2 gsm to about 30 gsm, or from about 5 gsm to about 30 gsm, or from about 5 gsm to about 15 gsm, or from about 8 gsm to about 12 gsm, or about 10 gsm.

The cellulose fiber layer can contain cellulose fibers, as described above. For example, in certain embodiments, the cellulose fiber layer can contain modified cellulose fibers, e.g., alone or in a blend with unmodified fibers. In certain embodiments, the cellulose fiber layer can have a basis weight of from about 20 gsm to about 150 gsm, or from about 20 gsm to about 100 gsm, or from about 20 gsm to about 80 gsm, or from about 20 gsm to about 60 gsm, or from about 20 gsm to about 50 gsm, or from about 20 gsm to about 45 gsm, or from about 25 gsm to about 50 gsm, or from about 25 gsm to about 45 gsm.

In certain embodiments, the cellulose fiber layer can further include one or more other fiber types. For example, and not limitation, the cellulose fibers of the cellulose fiber layer can be blended with synthetic fibers, fire retardant fibers, and/or mercerized fibers. For example, in certain embodiments, the cellulose fiber layer can contain bicomponent fibers. For example and not limitation, the bicomponent fibers can be present in the cellulose fiber layer in amount ranging from about 5 wt-% to about 50 wt-%, or from about 10 wt-% to about 40 wt-%, or from about 15 wt-% to about 30 wt-%, or about 15 wt-%, or about 30 wt-%. In particular embodiments, the bicomponent fibers can have a PET core with a polyethylene sheath arranged in a concentric configuration. If present, the bicomponent fibers in the cellulose fiber layer can have a low dtex, e.g., no more than about 5.7 dtex, no more than about 3.3 dtex, or no more than about 1.7 dtex. In particular embodiments, the bicomponent fibers can have a dtex of about 1.7 dtex.

As embodied herein, the cellulose fiber layer can be bonded on at least a portion of its outer surface with binder. It is not necessary that the binder chemically bond with a portion of the layer, although it is preferred that the binder remain associated in close proximity with the layer, by coating, adhering, precipitation, or any other mechanism such that it is not dislodged from the layer during normal handling of the layer. For convenience, the association between the layer and the binder discussed above can be referred to as the bond, and the compound can be said to be bonded to the layer. If present, the binder can be applied in amounts ranging from about 1 gsm to about 15 gsm, or from about 2 gsm to about 10 gsm, or from about 3 gsm to about 8 gsm.

In addition to the first synthetic layer and the cellulose fiber layer described above, the air filtration medium can further include additional layers. For example, one or more additional layers can be disposed between the first synthetic fiber layer and the cellulose fiber layer.

In certain embodied, the air filtration medium can include at least one additional synthetic fiber layer, e.g., a second synthetic fiber layer and a third synthetic fiber layer. In certain embodiments, the additional synthetic fiber layer can have the same composition as the first synthetic fiber layer. Alternatively, the additional synthetic fiber can differ from the first synthetic fiber layer, for example, in terms of fiber type, dtex, configuration, or basis weight. For example, and not limitation, the fibers of the additional synthetic fiber layer can have a dtex lower than those of the first synthetic fiber layer. In certain embodiments, the additional synthetic fiber layer can contain bicomponent fibers having a dtex of no more than about 5.7. In certain embodiments, the bicomponent fibers can have a PET or polypropylene core with a polyethylene sheath. In certain embodiments, the bicomponent fibers can have an eccentric configuration. Alternatively or additionally, the bicomponent fibers can have a concentric configuration. In alternative embodiments, the additional synthetic fiber layer can include mono-component synthetic fibers, such as PET fibers. The PET fibers can have a higher dtex, e.g., from about 5 dtex to about 7 dtex, or about 6.7 dtex. The additional synthetic fiber layer can include two or more types of bicomponent fibers. For example, in certain embodiments, the additional synthetic fiber layer can include at least two different bicomponent fibers that vary by fiber length, e.g., fibers having lengths of about 4 mm and about 6 mm.

As embodied herein, one or more additional synthetic fiber layers can include a blend of synthetic and cellulose fibers. For example, a synthetic fiber layer can include a combination of bicomponent fibers and cellulose fibers. In particular embodiments, the synthetic fiber layer can include bicomponent fibers having a PET core with a polyethylene sheath arranged in a concentric configuration blended with cellulose fibers. Such a blended synthetic fiber layer can contain from about 5 wt-% to about 50 wt-%, or from about 10 wt-% to about 40 wt-%, or from about 15 wt-% to about 30 wt-%, or about 15 wt-% bicomponent fibers. In certain embodiments, multiple layers including a blend of synthetic and cellulose fibers can be arranged consecutively to form a gradient from synthetic fibers to cellulose fibers.

In certain embodiments, the additional synthetic fiber layer can have a basis weight of from about 2 gsm to about 30 gsm, or from about 5 gsm to about 30 gsm, or from about 5 gsm to about 15 gsm, or from about 7 gsm to about 13 gsm, or from about 8 gsm to about 12 gsm, or about 10 gsm.

As described above, the cellulose fiber layer can be bonded on at least a portion of its outer surface with binder. Additionally or alternatively, the first synthetic fiber layer can be bonded on at least a portion of its outer surface with binder. In certain embodiments, the binder can be a fire-retardant binder, for example and not limitation, a vinyl-chloride containing copolymer, e.g., Wacker Vinnol 4530.

Additionally or alternatively, the air filtration medium described herein can include one or more additional layers. Such additional layers can include a variety of fibers, including but not limited to fully- or semi-treated CO™ pulp, mercerized fibers, and/or fire-retardant fibers, alone or in a blend with synthetic and/or cellulose fibers. In certain embodiments, such additional layers can be disposed between the first synthetic fiber layer and the cellulose fiber layer. Alternatively, one or more additional layers can be disposed adjacent to an outer surface of the cellulose fiber layer.

For example, in particular embodiments, a fire suppression layer can be disposed adjacent to an outer surface of the cellulose fiber layer, such that the cellulose fiber layer is disposed between the fire suppression layer and the first synthetic fiber layer (with optional additional layers therebetween, as described above). In certain embodiments, the fire suppression layer can comprise fire retardant fibers, such as Trevira-276 and/or Trevia-270. Alternatively or additionally, the fire suppression layer can include synthetic or cellulose fibers that have been chemically treated to provide fire retardant properties. As embodied herein, the fire suppression layer can have a basis weight of from about 2 gsm to about 25 gsm, or from about 3 gsm to about 20 gsm, or from about 4 gsm to about 15 gsm, or from about 5 gsm to about 10 gsm. The fire suppression layer can be coated on at least a portion of its outer surface with a binder, e.g., in an amount ranging from about 1 gsm to about 15 gsm, or from about 2 gsm to about 10 gsm, or from about 3 gsm to about 8 gsm.

In certain embodiments, the range of basis weight of the overall air filtration medium is from about 10 gsm to about 300 gsm, or from about 10 gsm to about 200 gsm, or from about 10 gsm to about 150 gsm, or from about 10 gsm to about 100 gsm, or from about 15 gsm to about 90 gsm, or from about 15 gsm to about 80 gsm, or from about 20 gsm to about 70 gsm, or from about 30 gsm to about 70 gsm, or from about 40 gsm to about 70 gsm, or from about 50 gsm to about 70 gsm.

The caliper of the air filtration medium refers to the caliper of the entire nonwoven material, inclusive of all layers. In certain embodiments, the caliper of the material ranges from about 0.5 mm to about 5.0 mm, or from about 0.5 mm to about 4.0 mm, or from about 0.5 mm to about 3.0 mm, or from about 0.5 mm to about 2.0 mm, or from about 0.7 mm to about 1.8 mm, or from about 0.8 mm to about 1.7 mm, or from about 0.9 mm to about 1.6 mm.

### Methods of Making the Air Filtration Medium

A variety of processes can be used to assemble the materials used in the practice of this disclosed subject matter to produce the materials, including but not limited to, traditional dry forming processes such as airlaying and carding or other forming technologies such as spunlace or airlace. Preferably, the materials can be prepared by airlaid processes. Airlaid processes include, but are not limited to, the use of one or more forming heads to deposit raw materials of differing compositions in selected order in the manufacturing process to produce a product with distinct strata. This allows great versatility in the variety of products which can be produced.

In one embodiment, the material is prepared as a continuous airlaid web. The airlaid web is typically prepared by disintegrating or defiberizing a cellulose pulp sheet or sheets, typically by hammermill, to provide individualized fibers. Rather than a pulp sheet of virgin fiber, the hammermills or other disintegrators can be fed with recycled airlaid edge trimmings and off-specification transitional material produced during grade changes and other airlaid production waste. Being able to thereby recycle production waste would contribute to improved economics for the overall process. The individualized fibers from whichever source, virgin or recycled, are then air conveyed to forming heads on the airlaid web-forming machine. A number of manufacturers make airlaid web forming machines suitable for use in the disclosed subject matter, including Dan-Web Forming of Aarhus, Denmark, M&J Fibretech A/S of Horsens, Denmark, Rando Machine Corporation, Macedon, N.Y. which is described in U.S. Pat. No. 3,972,092, Margasa Textile Machinery of Cerdanyola del Valles, Spain, and DOA International of Wels, Austria. While these many forming machines differ in how the fiber is opened and air-conveyed to the forming wire, they all are capable of producing the webs of the presently disclosed subject matter. The Dan-Web forming heads include rotating or agitated perforated drums, which serve to maintain fiber separation until the fibers are pulled by vacuum onto a foraminous forming conveyor or forming wire. In the M&J machine, the forming head is basically a rotary agitator above a screen. The rotary agitator can comprise a series or cluster of rotating propellers or fan blades. Other fibers, such as a synthetic thermoplastic fiber, are opened, weighed, and mixed in a fiber dosing system such as a textile feeder supplied by Laroche S. A. of Cours-La Ville, France. From the textile feeder, the fibers are air conveyed to the forming heads of the airlaid machine where they are further mixed with the comminuted cellulose pulp fibers from the hammer mills and deposited on the continuously moving forming wire. Where defined layers are desired, separate forming heads can be used for each type of fiber. Alternatively or additionally, one or more layers can be prefabricated prior to being combined with additional layers, if any.

The airlaid web is transferred from the forming wire to a calendar or other densification stage to densify the web, if necessary, to increase its strength and control web thickness. In one embodiment, the fibers of the web are then bonded by passage through an oven set to a temperature high enough to fuse the included thermoplastic or other binder materials. In a further embodiment, secondary binding from the drying or curing of a latex spray or foam application occurs in the same oven. The oven can be a conventional through-air oven, be operated as a convection oven, or can achieve the necessary heating by infrared or even microwave irradiation. In particular embodiments, the airlaid web can be treated with additional additives before or after heat curing.

### Air Filters

The air filtration media of the disclosed subject matter can be used for any application known in the art. For example, the air filtration media can be used either alone or as a component in a variety of air filter configurations. In certain aspects, the air filtration media can be sized to be placed within a filter housing. For example, in certain embodiments, the air filtration medium can be cut to an appropriate size and attached over an air filter to provide an inexpensive means for a high-quality filter cartridge. The air filtration medium can be the only medium used in the filter housing or can be used in combination with a charcoal filter, a HEPA filter, or other filtering media.

### Performance Characteristics

When used in an air filter, the air filtration medium of the presently disclosed subject matter can have improved initial filtration efficiency with additional benefits from its mold resistant and fire-retardant properties.

For example, an air filter in accordance with the present disclosure can have an estimated minimum efficiency reporting value (MERV) of at least about 6, or at least about 7. The components of estimated MERV, e.g., initial efficiency in channels 1-12 and for E1, E2, and E3, can be measured according to the ASHRAE 52.2 Test Standard.

In certain embodiments, air filters according to the disclosure subject matter can have improved initial efficiency in E3 (i.e., channels 9 to 12, corresponding to particle sizes of 3.0 μm to 10.0 μm), as compared to E1 (i.e., channels 1 to 4, corresponding to particle sizes of 0.3 μm to 1.0 μm) and E2 (i.e., channels 5 to 8, corresponding to particle sizes of 1.0 μm to 3.0 μm). For example, in certain embodiments, the initial efficiency in E3 can range from about 60% to about 100%, or from about 60% to about 95%, or from about 60% to about 90%, or from about 60% to about 85%, or from about 60% to about 80%, or from about 70% to about 80%. For example, the initial efficiency in E3 can be at least about 65%, at least about 70%, at least about 75%, or at least about 79%. In certain embodiments, the initial efficiency in E1 can range from about 5% to about 100%, or from about 5% to about 50%, or from about 5% to about 30%, or from about 5% to about 20%, or from about 5% about 15%, or from about 10% to about 15%. For example, the initial efficiency in E1 can be at least about 5%, at least about 10%, or at least about 12%. In certain embodiments, the initial efficiency in E2 can range from about 35% to about 100%, or from about 35% to about 80%, or from about 35% to about 70%, or from about 35% to about 65%, or from about 35% to about 60%, or from about 40% to about 60%, or from about 45% to about 60%. For example, the initial efficiency in E2 can be at least about 45%, at least about 50%, or at least about 55%.

Additionally and as embodied herein, the air filter media can be characterized as a multilayer nonwoven structure comprising layers of fibrous networks, each having synthetic and/or cellulosic fibers in such a manner that most of the synthetic fibers are in the layers closer to the surface of the medium (i.e., exposed to the air flowing into the medium) and most of the cellulosic fibers are closer to the opposite surface of the medium. The porosity of each layer in a multilayer structure can be characterized by the Fibrous Network Index (FNI). FNI is calculated by dividing the measured permeability of the layer by its calculated fiber volume and can be a proxy for the structural characteristics of the fibrous network created by a given fiber or fiber blend. In particular, FNI is calculated according to Formula 1, below, to obtain FNI in the units of ft/(min %):

$$FNI = \frac{\begin{matrix}Permeability of 50 gsm fibrous \\ network layer ( cfm )\end{matrix}}{Fiber Volume of fibrous netword layer ( \% )} \qquad ( Formula 1 )$$

The FNI can be converted to standard units of cm/s according to Formula 2:

$$FNI [ \frac{cm}{s} ] = 0.0197 FNI [ ft \text{/} ( min \% ) ] \qquad ( Formula 2 )$$

For the purpose of example and not limitation, and in certain embodiments, the layers with higher synthetic fiber content (e.g., from about 80 wt-% to about 100 wt-%) can be characterized with a Fibrous Network Index from about 100 ft/(min %) to about 1000 ft/(min %), alternatively from about 200 ft/(min %) to about 800 ft/(min %). In certain embodiments, the layer or layers closest to the surface exposed to the air flowing into the filter medium can have a lower FNI (for example from about 100 ft/(min %) to about 300 ft/(min %)) as compared to the adjacent layer or layers of the fibrous network having FNIs, for example, of from about 100 ft/(min %) to about 1000 ft/(min %). Without being bound by a particular theory, it is believed that this arrangement allows for better containment of dust particles by the air filter medium and improved capacity and filter efficiency. As embodied herein, the layers having higher cellulosic fiber content (e.g., from about 80 wt-% to about 100 wt-%) can be characterized by FNI values of from about 10 ft/(min %) to about 300 ft/(min %), alternatively from about 50 ft/(min %) to about 200 ft/(min %).

Moreover, as embodied herein, the air filter can have a desirable initial pressure drop across the air filtration medium. In designing air filtration media, pressure drop is an important characteristic that must be balanced appropriately, as it impacts the performance and energy efficiency of an air filter. For example, in certain embodiments, an air filter in accordance with the disclosure subject matter can create an initial pressure drop of from about 0.15″WG to about 0.35″WG, or from about 0.17″WG to about 0.32″WG, or from about 0.2″WG to about 0.3″WG, when measured according to the ASHRAE 52.2 Test Standard.

Further, the air filtration medium in accordance with the disclosed subject matter can have improved mold resistance. For example, when stored in a water bath or conditioning solution, the air filtration medium can have no observable mold after a time period of at least 1 day, at least 5 days, at least 1 week, at least 2 weeks, at least 5 weeks, at least 10 weeks, or at least 12 weeks.

Additionally, the air filtration medium in accordance with the disclosed subject matter can have longer acquisition times of moisture, and therefore, can be resistant to moisture in humid environments. For example, when placed in a water bath, the air filtration medium can resist becoming fully saturated for at least about 30 seconds, at least about 1 minute, at least about 2 minutes, at least about 3 minutes, at least about 4 minutes, at least about 5 minutes, at least about 6 minutes, or at least about 6 minutes and 30 seconds. Furthermore, the air filtration medium can be subjected to exposure in a conditioning chamber set to 100° F. and 90% relative humidity with no substantial changes to the physical characteristics of the medium (e.g., strength, thickness, and/or brightness).

Furthermore, air filtration medium prepared in accordance with the disclosed subject matter can have improved fire retardance. For example, upon being contacted with a flame, the presently disclosed materials can resist combustion and/or upon combustion can have reduced spread of the flame. For example, in certain embodiments, the air filtration medium can meet UL 900 standards for fire retardance.

### EXAMPLES

The following examples are merely illustrative of the presently disclosed subject matter and they should not be considered as limiting the scope of the subject matter in any way.

### Example 1: Four-Layer Air Filtration Medium

The present Example provides for a filter medium in accordance with the disclosed subject matter.

The filter medium of this Example was made using commercially available eccentric polyethylene/polypropylene (PE/PP) bicomponent fibers from Fibervisions (ESE452ALV, 5.7 dtex, 4 mm, Varde, Denmark). Commercially available concentric polyethylene/polypropylene (PE/PP) bicomponent fibers from Trevira (Trevira-257, 1.7 dtex, 6 mm, Varde, Denmark) were also used. Vinnapas-192, a commercially available binder from Wacker (Allentown, Pa.), was used along with Golden Isles® 4723, a fully-treated pulp made by GP Cellulose.

A 60 gsm substrate having a 4-layer construction and coated with a binder, as shown in Table 1 below, was made on a commercial Dan Webb air laid line, slit to 24 inches wide and co-pleated.

TABLE 1
Fibervisions 5.7 dtex Eccentric Bico (10 gsm)
Fibervisions 5.7 dtex Eccentric Bico (10 gsm)
15 wt-% Trevira-257 (2.1 gsm)/85 wt-% GI-4723 (11.8 gsm)
GI-4723 Fully Treated Pulp (23.4 gsm)
Vinnapas-192 (2.7 gsm)

These wire-backed filter packs were then hand fabricated into 24″×24″×2″ and 24″×24″×4″ filters with 29 pleats each. The filters were then tested for initial efficiency and initial pressure drop. The 4″ filter tested at an estimated MERV 7 with an initial pressure drop of 0.22″ WG, while the 2″ filter tested at an estimated MERV 8 with an initial pressure drop of 0.17″ WG under standard air flow rates proscribed by the ASHRAE 52.2 Test Standard.

Thus, this Example demonstrated that filter media in accordance with the disclosed subject matter having a layer of modified cellulose fibers and a layer of synthetic fibers, directionally layered with an intermediate layer having both cellulose fibers and synthetic fibers, delivered desirable filtration performance, with an estimated MERV of about 7 to about 8.

### Example 2: Filter Medium Initial Efficiency

This Example further studies the initial efficiency of the substrates of Example 1. A roll of the 60 gsm substrate described in Example 1 and depicted in Table 1, above, was wire-laminated, pleated, and assembled as 24″×24″×2″ filters, each with 27 pleats. Three such filters were tested for initial efficiency, and had an average estimated MERV 7 rating, an average initial pressure drop of 0.21″ WG, and an average dust holding capacity of 105 grams.

### Example 3: Pilot Plant Trial of Filtration Medium with Binder Having Fire Retardant Properties

This Example describes several filtration media in accordance with the disclosed subject matter and including a binder.

The materials of this Example were made using two commercially available eccentric polyethylene/polypropylene (PE/PP) bicomponent fibers from Fibervisions (FV) (ESE452ALV, 5.7 dtex, 4 mm and ESE430ALV, 3.3 dtex, 4 mm, Varde, Denmark). Commercially available concentric polyethylene/polypropylene (PE/PP) bicomponent fibers from Trevira (Trevira-257, 1.7 dtex, 6 mm, Varde, Denmark) were also used. Vinnapas-192 and Vinnol 4530, two commercially available binders from Wacker (Allentown, Pa.), were used along with Golden Isles® 4723, a fully-treated pulp made by GP Cellulose.

In this Example, the binder Vinnol 4530 (an ethylene vinyl chloride binder) was introduced to stiffen the material and provide fire retardant properties. The introduction of different gradient layers using synthetic fibers was compared to an initial substrate (Sample 3E), similar to that tested in Examples 1 and 2.

Five different grades of air filtration media (structures shown in Table 2, below) were prepared on a Dan Webb air laid pilot line and slit to a 16″ width.

TABLE 2

| | Sample | Sample | Sample | Sample | Sample 3E |
|---|---|---|---|---|---|
| Structure | 3A | 3B | 3C | 3D | (CONTROL) |
| Bicomponent | 10 gsm | 10 gsm | 10 gsm | 10 gsm | 10 gsm |
| Fiber | FV 5.7 | FV 3.3 | FV 3.3 | FV 5.7 | FV 5.7 |
| | dtex | dtex | dtex | dtex | dtex |
| Bicomponent | 10 gsm | 10 gsm | 10 gsm | 10 gsm | 10 gsm |
| Fiber | FV 3.3 | FV 5.7 | FV 3.3 | FV 5.7 | FV 5.7 |
| | dtex | dtex | dtex | dtex | dtex |
| 15% T-257/ | 37 gsm | 37 gsm | 37 gsm | 37 gsm | 37 gsm |
| GI-4723 | | | | | |
| Vinnol 4530 | 3 gsm | 3 gsm | 3 gsm | 3 gsm | 3 gsm |
| | | | | | Vinnapas-192 |

All substrates were prepared using 15% solids binder at a spray rate of approximately 470 mL/min (74% Spray rate). A temperature ladder from 132° C. to 136° C. was performed to determine that 132° C. was the optimum temperature for the substrate, and that temperature was used for all three ovens. All samples were prepared using no compaction. The calipers of each material were measured in millimeters using replicates of 5 (8 measurements per 12×12 inch sample) on a Thwing-Albert Pro Gage. The permeabilities of each material were measured in cubic feet/minute using replicates of 5 on a FX 3300 Air Permeability Tester set to a test pressure of 125 Pascals. Each roll was fabricated into 16″×20″×2″ inch wire-backed high capacity filters (with the cellulosic side touching the metal). The characteristics of the filters are summarized in Table 3, below.

TABLE 3

| Filter Parameters | Units | Samples 3A-3E |
|---|---|---|
| # Pleats | | 25 |
| Nominal Dimensions | in | 20 × 16 × 2 |
| Est. Gross Media Area | ft² | 9.72 |
| Airflow Rate | cfm | 1093 |
| Nominal Face Velocity | ft/min | 492 |

The finished filters were then tested for initial efficiency and initial pressure drop under standard air flow rates proscribed by the ASHRAE 52.2 Test Standard. The results are provided in Table 4, below, and compared to a commercially available Grainger filter, with a known MERV of 8.

TABLE 4

| | | | | | | | | | Initial |
|---|---|---|---|---|---|---|---|---|---|
| | | Basis | | | | | | | Pressure |
| | | Weight | Caliper | Permeability | | | | Estimated | Drop |
| Sample | Description | (gsm) | (mm) | (cfm) | E1 | E2 | E3 | MERV | (“WG) |
| Grainger | Commercial | 70 | 1.53 | 560 | — | — | — | — | — |
| Filter | Sample | | | | | | | | |
| 3A | 5.7/3.3 dtex | 56 | 1.12 | 548 | 5 | 39 | 67 | 7 | 0.27 |
| | MBAL | | | | | | | | |
| 3B | 3.3/5.7 dtex | 56 | 1.18 | 589 | 9 | 48 | 72 | 8 | 0.32 |
| | MBAL | | | | | | | | |
| | Backwards | | | | | | | | |
| 3C | 3.3 dtex | 57 | 1.54 | 579 | 7 | 39 | 64 | 7 | 0.28 |
| | MBAL | | | | | | | | |
| 3D | 5.7 dtex | 56 | 0.96 | 573 | 6 | 40 | 68 | 7 | 0.27 |
| | MBAL | | | | | | | | |
| 3E | Internal | 56 | 0.99 | 557 | 7 | 38 | 67 | 7 | 0.28 |
| | Control | | | | | | | | |

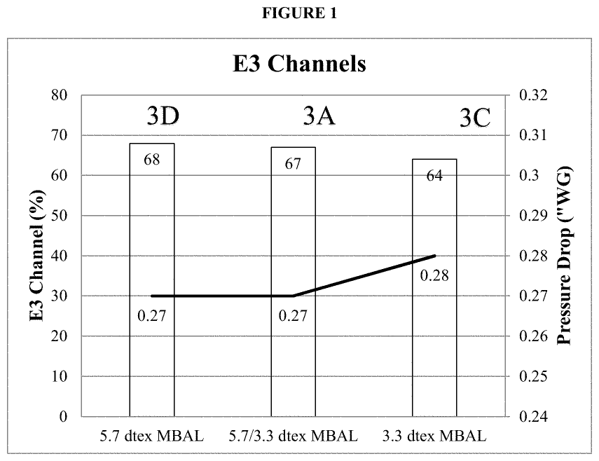

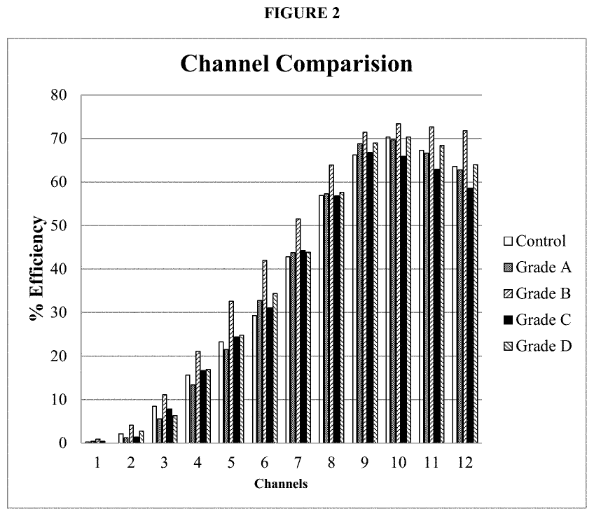

Additionally, FIGS. 1 and 2 further illustrate the initial efficiency of each sample. FIG. 1 shows initial pressure drop and initial efficiency in E3, which is indicative of the initial efficiency for particle sizes ranging from 3.0 to 10.0 μm. As shown in FIG. 1, while the initial pressure drop increased for the 3.3 dtex sample (Sample 3C), initial efficiency in E3 was similar for Samples 3A, 3C, and 3D. For further comparison, FIG. 2 provides the initial removal efficiency for particle size, broken out in channels 1-12, and shows that initial efficiency was greatest in the E3 channels (i.e., 9-12, corresponding to 3.0 to 10.0 μm), as compared to the E1 and E2 channels (i.e., 1-4, corresponding to 0.3-1.0 μm, and 5-8, corresponding to 1.0 to 3.0 μm, respectively). To improve initial efficiency in the E1 and E2 channels, the dtex of one or more layers could be reduced to less than 3.3 dtex.

The substitution of Vinnol 4530 appears to have no impact on initial efficiency performance making it an adequate replacement for Vinnapas 192. The use of 3.3 dtex fibers in Samples 3B and 3C did not result in a significant increase in E3 values. Additionally, Sample 3B was fabricated with the synthetic side touching the metal and resulted in higher initial efficiency but a larger initial pressure drop. Thus, the addition of a stiffening binder did not significantly impact the initial efficiency of the filtration media.

Additionally, a crude burn test was performed to observe the fire retardance of each roll, prior to fabrication of the final filter samples. 5″×5″ flat sheets of each sample were placed in a metal tray. Both the middle and corner of the sample were lit on fire using a lighter. The burning was recorded on video and the time for complete burn of the material (or extinguishing of the flame) was also measured. Visual observations regarding fire retardance at the middle and corner of each roll are provided in Table 5, below.

TABLE 5

| | Basis | | |
|---|---|---|---|
| | Weight | Time to | |
| | (gsm) | Burn (s) | Observations |
| 60 NTL, Roll | | | |
| X, Middle | | | |
| Grainger Filter | 71 | N/A | Only burned where flame directly |
| | | | touched |
| 3A | 55 | 50 | Lots of ash, big flame, incomplete |
| | | | burn |
| 3B | 55 | 51 | Big flame, can see sparks |
| 3C | 58 | 47 | Big flame, burned quickly, ashy |
| 3D | 64 | 52 | Burned slowly, small flame, left ash |
| | | | residue and extinguished |
| 3E | 57 | 38 | Burned quickly with no ash , |
| | | | remaining larger flame, took longer |
| | | | to extinguish |
| 60 NTL, Roll | | | |
| X, Corner | | | |
| Grainger Filter | 71 | N/A | Only burned where flame directly |
| | | | touched. |
| 3A | 59 | 65 | Huge flame, green stayed lit after |
| | | | material burned |
| 3B | 55 | 70 | Big flame, green, very smokey |
| 3C | 57 | 73 | Big flame, burned quickly, stayed lit |
| | | | after material burned for long time |
| 3D | 63 | 88 | Burned slow, small flame, left ash, |
| | | | extinguished quickly once burning |
| | | | was done |
| 3E | 56 | 48 | Burned quick, no ash remaining, |
| | | | bigger flame, longer to extinguish |

As described in Table 5, samples from Roll 3D burned slowly and were quick to extinguish. Thus, these samples were found to have improved fire retardance as compared to the Control, Roll 3E, which did not include the stiffening binder.

### Example 4: Filtration Media with Foley FFLE+ Pulp and 1.7 Dtex Polyethylene/Polypropylene Fibers

In this Example, filtration media were prepared with modified cellulose fibers, in accordance with the present disclosure.

The materials of this Example were made using two commercially available eccentric polyethylene/polypropylene (PE/PP) bicomponent fibers from Fibervisions (ESE452ALV, 5.7 dtex, 4 mm and ESE430ALV, 3.3 dtex, 4 mm, Varde, Denmark). Commercially available concentric polyethylene/polypropylene (PE/PP) bicomponent fibers from Trevira (Trevira-257, 1.7 dtex, 6 mm, Varde, Denmark) were also used. Additionally, Vinnapas-192 and Vinnol 4530, two commercially available binders from Wacker (Allentown, Pa.), were used. The cellulose fibers Foley FFLE+, an Al-treated pulp made by GP Cellulose, and Golden Isles® 4723, a fully-treated pulp made by GP Cellulose, were also used in the present examples.

This Example compared samples with FFLE+Pulp (Samples 4A-4B and 4F-4I) to a control with GI-4723 fully-treated pulp (Sample 4C) to evaluate the potential anti-microbial properties of modified cellulose pulp and the interaction between FFLE+pulp and specific synthetic fibers to produce a hydrophobic (and therefore moisture resistant) layer. This interaction is described more fully in U.S. Pat. No. 8,946,100, the contents of which are hereby incorporated by reference in their entirety. Smaller dtex fibers were also evaluated within the gradient structures. The present examples were made both as substrates containing binder (Samples 4A, 4C-4F, 4H, and 4I), which are labeled as MBAL (Multi-Bonded Air Laid) structures, and as substrates without a binder (Samples 4B and 4G), which are labeled as TBAL (Thermally-Bonded Air Laid) structures. Additional details regarding the composition and target basis weights of Samples 4A-4I are provided in Table 6, below.

TABLE 6
Sample 4A
5.7 dtex Eccentric PE/PP (10 gsm)
5.7 dtex Eccentric PE/PP (10 gsm)
FFLE + (31.5 gsm)/T-257 (5.5 gsm)
V-192 (3 gsm)
Sample 4B
5.7 dtex Eccentric PE/PP (10 gsm)
5.7 dtex Eccentric PE/PP (10 gsm)
FFLE + (28 gsm)/T-257 (12 gsm)
No Binder
Sample 4C (CONTROL)
5.7 dtex Eccentric PE/PP (10 gsm)
5.7 dtex Eccentric PE/PP (10 gsm)
GI-4725 (31.5 gsm)/T-257 (5.5 gsm)
V-4530 (3 gsm)
Sample 4D
5.7 dtex Eccentric PE/PP (10 gsm)
5.7 dtex Eccentric PE/PP (10 gsm)
FFLE + (31.5 gsm)/T-257 (5.5 gsm)
V-4530 (3 gsm)
Sample 4E
5.7 dtex Eccentric PE/PP (10 gsm)
5.7 dtex Eccentric PE/PP (10 gsm)
FFLE + (31.5 gsm)/T-257 (5.5 gsm)
V-4530 (6 gsm)
Sample 4F
3.3 dtex Eccentric PE/PP (10 gsm)
5.7 dtex Eccentric PE/PP (10 gsm)
FFLE + (31.5 gsm)/T-257 (5.5 gsm)
V-4530 (3 gsm)
Sample 4G
3.3 dtex Eccentric PE/PP (10 gsm)
5.7 dtex Eccentric PE/PP (10 gsm)
FFLE + (28 gsm)/T-257 (12 gsm)
No Binder
Sample 4H
3.3 dtex Eccentric PE/PP (10 gsm)
T-257 (10 gsm)
FFLE + (31.5 gsm)/T-257 (5.5 gsm)
V-4530 (3 gsm)
Sample 4I
5.7 dtex Eccentric PE/PP (10 gsm)
T-257 (10 gsm)
FFLE + (31.5 gsm)/T-257 (5.5 gsm)
V-4530 (3 gsm)

The samples were prepared on a Dan Webb air laid pilot line. The calipers of each material were measured in millimeters using replicates of 3 (8 measurements per 12×12 inch sample) on a Thwing-Albert Pro Gage. The permeabilities of each material were measured from both the synthetic side (Permeability S) and the cellulosic side (Permeability C) in cubic feet/minute using replicates of 3 on a FX 3300 Air Permeability Tester set to a test pressure of 125 Pascals, as provided in Table 7, below. Table 7 also provides the measured basis weights and calipers of each sample. Flat sheet materials of Samples 4A, 4B, 4C, and 4D were also tested for zone of inhibition and microbial-resistance testing.

TABLE 7

| | Basis | | | |
|---|---|---|---|---|
| | Weight | Caliper | Permeability | Permeability |
| Sample | (gsm) | (mm) | S | C |
| 4A | 55 | 1.13 | 536 | 535 |
| 4B | 59 | 1.37 | 510 | 507 |
| 4C | 60 | 1.43 | 516 | 515 |
| 4D | 59 | 1.32 | 543 | 541 |
| 4E | 59 | 1.24 | 505 | 506 |
| 4F | 59 | 1.32 | 468 | 467 |
| 4G | 61 | 0.94 | 419 | 416 |
| 4H | 59 | 1.21 | 448 | 448 |
| 4I | 61 | 0.96 | 401 | 400 |

Each roll was fabricated into 20×20×2 inch wire-backed high capacity filters (with the cellulosic side touching the metal). The characteristics of the filters are summarized in Table 8, below. Sample 4I was fabricated into a 16×20×2 inch wire-backed high capacity filter (with the cellulose side touching the metal) and its characteristics are also summarized in Table 8. Flat sheet laminated materials of Samples 4A, 4B, 4C, 4D, 4E, and 4G were placed in a clean conditioning chamber for two weeks at 80° F. and 90% Humidity. The finished filters were tested for initial efficiency and initial pressure drop under standard air flow rates proscribed by the ASHRAE 52.2 Test Standard. The initial efficiency and initial pressure drop are provided in Table 9, below.

TABLE 8

| Filter Parameters | | 4A-4H | 4I |
|---|---|---|---|
| # of Pleats | | 19 | 19 |
| Nominal Dimensions | in | 20 × 20 × 2 | 16 × 20 × 2 |
| Est. Gross Media Area | ft² | 9.24 | 9.24 |
| Airflow Rate | cfm | 1367 | 1093 |
| Nominal Face Velocity | ft/min | 492 | 492 |

TABLE 9

| | | Filter Performance | | | | |
|---|---|---|---|---|---|---|
| | | | | | | Initial |
| | | Estimated | | | | Pressure Drop |
| Sample | Descriptions | MERV | E1 | E2 | E3 | (“WG) |
| 4A | V-192 MBAL | 8 | 12 | 51 | 71 | 0.31 |
| 4B | 5.7 dtex TBAL | 8 | 10 | 49 | 72 | 0.29 |
| 4C | GI-4725 Control | 9 | 13 | 54 | 77 | 0.29 |
| 4D | 5.7 dtex MBAL | 8 | 10 | 48 | 70 | 0.28 |
| 4E | 2xV-4530 | 7 | 12 | 49 | 66 | 0.27 |
| | MBAL | | | | | |
| 4F | 3.3/5.7 dtex | 7 | 10 | 49 | 68 | 0.29 |
| | MBAL | | | | | |
| 4FF | R 3.3/5.7 dtex | 9 | 13 | 55 | 79 | 0.30 |
| | MBAL | | | | | |
| 4G | 3.3/5.7 dtex | 9 | 11 | 55 | 78 | 0.32 |
| | TBAL | | | | | |
| 4H | 3.3/1.7 dtex | 9 | 13 | 55 | 77 | 0.31 |
| | MBAL | | | | | |
| 4I | 5.7/1.7 dtex | 8 | 11 | 50 | 74 | 0.32 |
| | MBAL | | | | | |

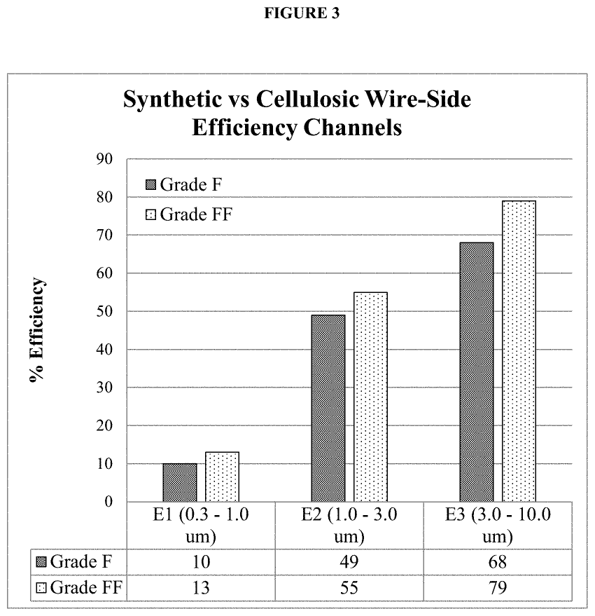

Samples 4F and 4FF represent the same media fabricated with the cellulosic side touching the wire (Sample 4F) and the synthetic side touching the wire (Sample 4FF) to compare differences in initial efficiency performance controlled by the directional nature of the media. As shown in FIG. 3, Sample 4FF, which was prepared with the synthetic side touching the wire, had slightly improved initial efficiency.

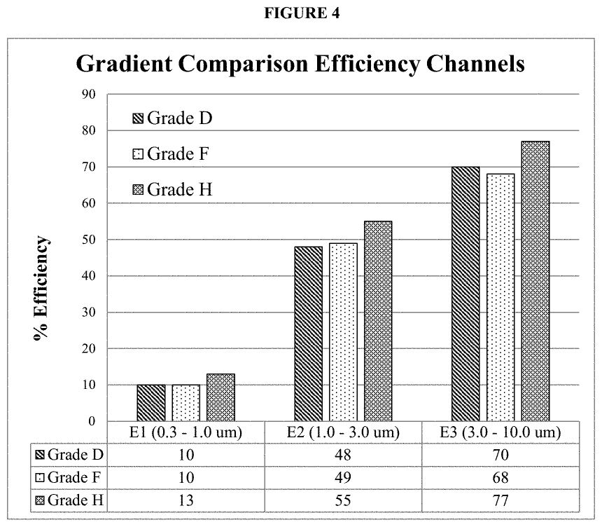

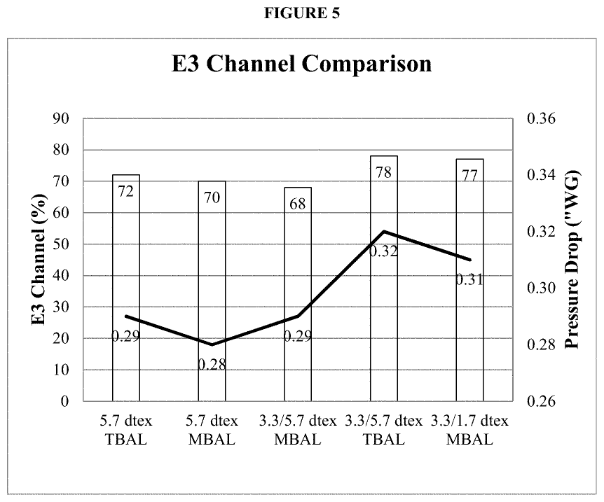

FIGS. 4 and 5 compare the initial efficiency of Samples 4D, 4F, and 4H, which each include different dtex fibers, in order to show the versatile capability of an air laid structure to impact the initial efficiency performance of air filtration media. For example, FIG. 4 provides a comparison of the initial efficiency in E1, E2, and E3 channels across these three samples. Sample 4H, which had the smallest dtex, had the greatest initial efficiency across all channels. FIG. 5 provides a further comparison of the efficiencies Samples 4D, 4F, and 4H, along with TBAL Samples 4B and 4G, in the E3 channels. Of the MBAL samples, Sample 4H had the greatest initial efficiency in E3. Of the TBAL samples, Sample 4G had the greatest initial efficiency in the E3 channels. This result suggests that thermally-bonded materials without a binder have greater initial efficiency at these pore sizes, although the results also confirm that lower dtex samples generally have improved initial efficiency, as well as a higher initial pressure drop.

Mold organisms A. brasiliensis and P. chrysogenum were introduced to Samples 4A-4D, and the samples were subjected to a slightly modified version of the Kirby-Bauer Disk Diffusion Test. The results are shown in Table 10, below. Samples 4B and 4D showed no growth of P. chrysogenum and A. brasiliensis, respectively. Zone of inhibition testing on Samples 4A-4D also indicated that the anti-microbial properties present in the pulp do not leach out from the substrate, as no clear zones of inhibited growth were observed.

TABLE 10

| Sample | A. brasiliensis | P. chrysogenum |
|---|---|---|
| 4A | Partial | Growth |
| 4B | Partial | No Growth |
| 4C | Partial | Partial |
| 4D | No Growth | Partial |

Samples 4A-4D were also subjected to antibacterial activity testing using a slightly modified ISO 20743 standard. Antimicrobial activity values from this test method are provided in Table 11, below. All 4 substrates could inhibit the growth of bacteria S. aureus, but Samples 4A and 4D showed the highest inhibition levels after 4 hours and Sample 4D showed the highest inhibition levels after 24 hours. The test was modified to use mold organism A. brasiliensis, and the substrates were shown to partially inhibit growth. Samples 4B and 4D showed the highest inhibition levels against S. brasoliensis after 4 hours. These early test results indicate that FFLE+ can be used to inhibit mold growth on the cellulose present in the air filtration media.

TABLE 11

| | | | |
|---|---|---|---|
| Sample 4A | Sample 4B | Sample 4C | Sample 4D |

Staphylococcus aureus (ATCC ® 6538 ™)

| | | | | |
|---|---|---|---|---|
| 4 hours | 2.679 | 0.988 | 0.549 | 2.251 |
| 24 hours | 2.165 | 1.975 | 2.877 | 6.476 |

Aspergillus brasiliensis (ATCC ® 16404 ™)

| | | | | |
|---|---|---|---|---|
| 4 hours | 0.099 | 0.124 | 0.024 | 0.204 |

Additionally, Samples 4A-4E and 4G showed no visible moisture sensitivity after remaining in the conditioning chamber for two weeks, indicating the air filtration media will not easily collapse when exposed to high temperatures and humidity despite the high amount of cellulose present in the substrate.

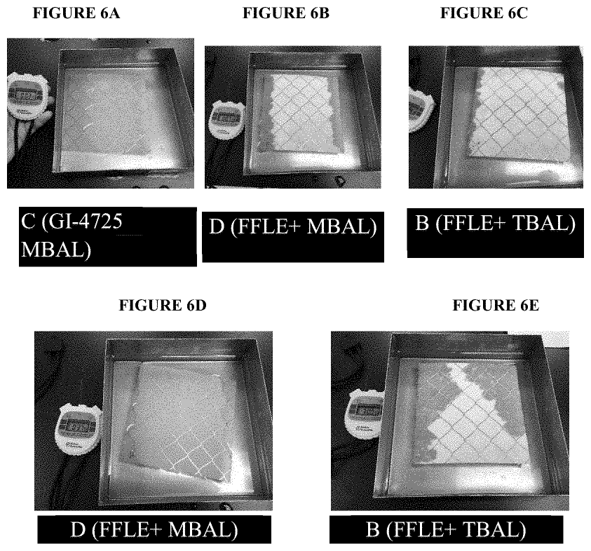

The presently disclosed substrate including modified cellulose fibers is advantaged through the hydrophobic interaction between FFLE+pulp and Trevira-257 bicomponent fibers in comparison to other standard pulps. For example, 5″×5″ laminated flat sheet samples of Samples 4B, 4C, and 4D were placed in a water bath with the wire side facing up and a timer was started immediately. Once the substrate sample was completely saturated with water, the timer was stopped. FIGS. 6A-6C show images of Sample 4C (5.7 dtex GI-4725 MBAL) after 3 seconds in water, Sample 4D (5.7 dtex FFLE+ MBAL) after 7 seconds in water, and Sample 4B (5.7 dtex FFLE+ TBAL) after 24 seconds in water, respectively.

FIGS. 6D and 6E show Sample 4D after 37 seconds and Sample 4B after 3 minutes, respectively. Complete saturation took 37 seconds for Sample 4D and six minutes and 32 seconds for Sample 4B. Table 12, below, shows the percent saturation at 7 seconds, along with the time needed to achieve full saturation. These data show that the incorporate of modified cellulose fibers can slow the uptake of moisture, resulting in a more durable filtration medium.

TABLE 12

| | % Saturation | Complete |
|---|---|---|
| Sample | at 7 seconds | Saturation (seconds) |
| 4B | <10% | 392 |
| 4C | 100% | 3 |
| 4D | 25% | 37 |

### Example 5: Structures Using Eccentric PE/PP Bicomponent Fibers

This Example provides sample materials with two synthetic fiber layer and third layer having a blend of synthetic and modified cellulose fibers.

The materials of this Example were made with commercially available eccentric polyethylene/polypropylene (PE/PP) bi-component fibers from Fibervisions (ESE452ALV, 5.7 dtex, 4 mm and/or ESE430ALV, 3.3 dtex, 4 mm and/or ESE420ALV, 2.2 dtex, 6 mm, Varde, Denmark). Commercially available concentric polyethylene/polypropylene (PE/PP) bicomponent fibers from Trevira (Trevira-257, 1.7 dtex, 6 mm, Varde, Denmark) were also used. Additionally, commercially available Foley FFLE+, an Aluminum-treated pulp made by GP Cellulose, and Vinnol 4530, a commercially available binder from Wacker (Allentown, Pa.), were used.

Six samples representing six different grades of air filter media (Samples 5A-5F) were prepared on a Dan Webb air laid pilot line. The calipers of each material were measured in millimeters using replicates of 3 (8 measurements per 12×12 inch sample) on a Thwing-Albert Pro Gage. The permeability of each material was measured from both the synthetic side (Permeability S) and the cellulosic side (Permeability C) in cubic feet/minute using three replicates on a FX 3300 Air Permeability Tester set to a test pressure of 125 Pascals. The structures (with target basis weights) of Samples 5A-5F are shown in Table 13, below.

TABLE 13

| Sample 5A | Sample 5D |
|---|---|
| 5.7 dtex Eccentric (10 gsm) | 5.7 dtex Eccentric (10 gsm) |
| 3.3 dtex Eccentric (10 gsm) | 2.2 dtex Eccentric (10 gsm) |
| FFLE+ (31.5 gsm)/T-257 (5.5 gsm) | FFLE+ (28 gsm)/T-257 (12 gsm) |
| V-4530 (6 gsm) | No Binder |
| Sample 5B | Sample 5E |
| 3.3 dtex Eccentric (10 gsm) | 3.3 dtex Eccentric (10 gsm) |
| 2.2 dtex Eccentric (10 gsm) | 2.2 dtex Eccentric (10 gsm) |
| FFLE+ (31.5 gsm)/T-257 (5.5 gsm) | FFLE+ (28 gsm)/T-257 (12 gsm) |
| V-4530 (6 gsm) | No Binder |
| Sample 5C | Sample 5F |
| 5.7 dtex Eccentric (10 gsm) | 3.3 dtex Eccentric (10 gsm) |
| 3.3 dtex Eccentric (10 gsm) | 3.3 dtex Eccentric (10 gsm) |
| FFLE+ (28 gsm)/T-257 (12 gsm) | FFLE+ (28 gsm)/T-257 (12 gsm) |
| No Binder | No Binder |

Each roll was fabricated into 20×20×2 inch wire-backed high capacity filters (with the cellulosic side touching the metal). The finished filters were tested for initial efficiency and pressure drop under standard air flow rates proscribed by the ASHRAE 52.2 Test Standard. The characteristics of the filters are summarized in Table 14, below. The initial efficiency and initial pressure drop are provided in Table 15, below, along with the measured calipers and basis weights for each sample.

TABLE 14

| Filter Parameters | | 5A-5F |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 15

| | | In-Lab Analysis Pre- | | | Filter Performance | | | | |
|---|---|---|---|---|---|---|---|---|---|
| | | Fabrication | | | | | | | Initial |
| | | BW | Caliper | Permeability | Estimated | | | | Pressure |
| Sample | Description | (gsm) | (mm) | (cfm) | MERV | E1 | E2 | E3 | Drop |
| 5A | 5.7/3.3 | 61 | 1.57 | 588 | 7 | 7 | 41 | 62 | 0.25 |
| | MBAL | | | | | | | | |
| 5B | 5.7/3.3 | 61 | 1.91 | 549 | 7 | 9 | 41 | 63 | 0.24 |
| | TBAL | | | | | | | | |
| 5C | 5.7/2.2 | 60 | 1.52 | 518 | 7 | 9 | 43 | 63 | 0.28 |
| | TBAL | | | | | | | | |
| 5D | 3.3/2.2 | 60 | 1.42 | 466 | 7 | 10 | 44 | 65 | 0.27 |
| | TBAL | | | | | | | | |
| 5E | 3.3/2.2 | 64 | 1.44 | 463 | 8 | 9 | 47 | 72 | 0.27 |
| | MBAL | | | | | | | | |
| 5F | 3.3/3.3 | 59 | 1.48 | 499 | 7 | 10 | 43 | 67 | 0.24 |
| | TBAL | | | | | | | | |

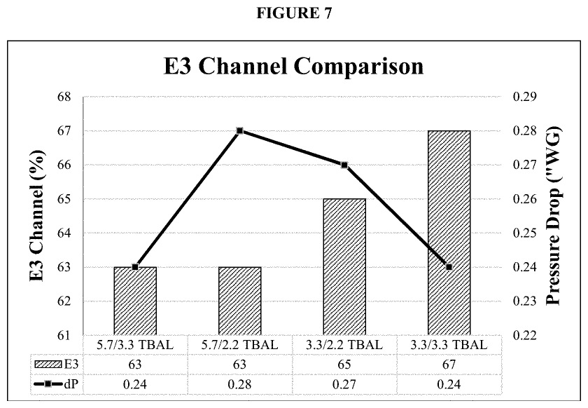

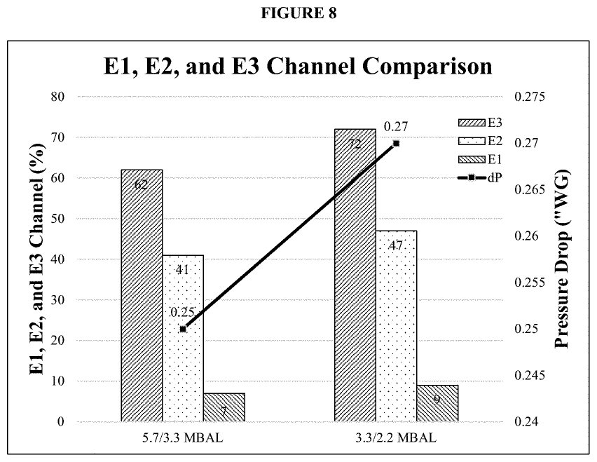

FIG. 7 provides a comparison of the initial efficiencies of the TBAL samples (Samples 5B, 5C, 5D, and 5F), in the E3 channels. Of the TBAL samples, Sample 5F had the greatest initial efficiency in E3, suggesting that thermally-bonded materials without a binder have greater initial efficiency (e.g., as compared to Sample 5B). Additionally, FIG. 8 compares the initial efficiencies of the MBAL samples (Samples 5A and 5E) across the E1, E2, and E3 channels. The sample without binder (Sample 5E) had increased initial efficiency across all channels as compared to the sample with binder (Sample 5A).

Additionally, Sample 5A was subjected to a 28 Day Challenge Test using the USP-51 Challenge Test protocol for Antimicrobial Effectiveness Test with minor modifications. The requirements for antimicrobial effectiveness under the 28 Day Challenge Test were met if there was more than 90% (1 log 10) reduction of mold within 7 days, and no increase thereafter, where “no increase” is defined as not more than a 0.5 log 10 unit higher than the previous value measured. A section of the Sample 5A was removed and tested at each time point (0, 7, 14, and 28 days), and it passed against both tested fungal strains (Aspergillus brasiliensis, ATCC® 16404™ and Penicillium chrysogenum, ATCC® 10106™).

### Example 6: Structures Using High Core PE/PET Bicomponent Fibers

This Example provides sample materials that include high core PE/PET bicomponent fibers.

The materials of this Example were made using commercially available eccentric polyethylene/polypropylene (PE/PP) bicomponent fibers from Fibervisions (ESE452ALV 5.7 dtex, 4 mm and/or ESE430ALV 3.3 dtex, 4 mm and/or ESE420ALV 2.2 dtex, 6 mm, Varde, Denmark). Commercially available Trevira-1661 2.2 dtex, 6 mm concentric polyethylene/polyester (PE/PET) bicomponent fibers were also used in certain samples. High core, 1.7 dtex, 6 mm concentric polyethylene/polyester (PE/PET) fibers featuring a 70% PET core from Trevira (Varde, Denmark) were also used. Vinnol 4530, a commercially available binder from Wacker (Allentown, Pa.), and Foley FFLE+, an Al-treated pulp made by GP Cellulose, were also used in the samples.

Four samples representing four different grades of air filter media (Samples 6A-6D) were prepared on a Dan Webb air laid pilot line. The calipers of each material were measured in millimeters using replicates of 3 (8 measurements per 12×12 inch sample) on a Thwing-Albert Pro Gage. The permeability of each material was measured from both the synthetic side in cubic feet/minute using three replicates on a FX 3300 Air Permeability Tester set to a test pressure of 125 Pascals. The structures of Samples 6A-6D are shown in Table 16, below.

TABLE 16

| Sample 6A | Sample 6C |
|---|---|
| 5.7 dtex Eccentric (10 gsm) | 5.7 dtex Eccentric (13 gsm) |
| 2.2 dtex Eccentric (10 gsm) | High Core 1.7 dtex T-255 (7 gsm) |
| FFLE+ (31.5 gsm)/T-1661 | FFLE+ (31.5 gsm)/T-1661 |
| (5.5 gsm) | (5.5 gsm) |
| V-4530 (6 gsm) | V-4530 (6 gsm) |
| Sample 6B | Sample 6D |
| 5.7 dtex Eccentric (20 gsm) | 5.7 dtex Eccentric (20 gsm) |
| FFLE+ (11.2 gsm)/High Core | FFLE+ (11.2 gsm)/T-1661 |
| T-255 (4.8 gsm) | (4.8 gsm) |
| FFLE+ (16.8 gsm)/T-1661 | FFLE+ (16.8 gsm)/T-1661 |
| (7.2 gsm) | (7.2 gsm) |
| No Binder | No Binder |

Each roll was fabricated into 20×20×2 inch wire-backed high capacity filters (with the cellulosic side touching the metal). The finished filters were tested for initial efficiency and pressure drop under standard air flow rates proscribed by the ASHRAE 52.2 Test Standard. The characteristics of the filters are summarized in Table 17, below. The initial efficiency and initial pressure drop are provided in Table 18, below.

TABLE 17

| Filter Parameters | | 6A-6D |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 18

| | | In-Lab Analysis Pre- | | | Filter Performance | | | | |
|---|---|---|---|---|---|---|---|---|---|
| | | Fabrication | | | | | | | Initial |
| | | BW | Caliper | Permeability | Estimated | | | | Pressure |
| Sample | Description | (gsm) | (mm) | (cfm) | MERV | E1 | E2 | E3 | Drop |
| 6A | 5.7/2.2 | 62 | 2.33 | 628 | 7 | 11 | 43 | 50 | 0.27 |
| | MBAL | | | | | | | | |
| 6B | 5.7/High Core | 58 | 2.20 | 657 | 7 | 8 | 39 | 56 | 0.27 |
| | & FFLE | | | | | | | | |
| | TBAL | | | | | | | | |
| 6C | 5.7/High Core | 62 | 2.26 | 651 | 7 | 7 | 41 | 56 | 0.26 |
| | MBAL | | | | | | | | |
| 6D | 5.7/T-1661 & | 59 | 2.34 | 656 | 7 | 8 | 36 | 51 | 0.23 |
| | FFLE TBAL | | | | | | | | |

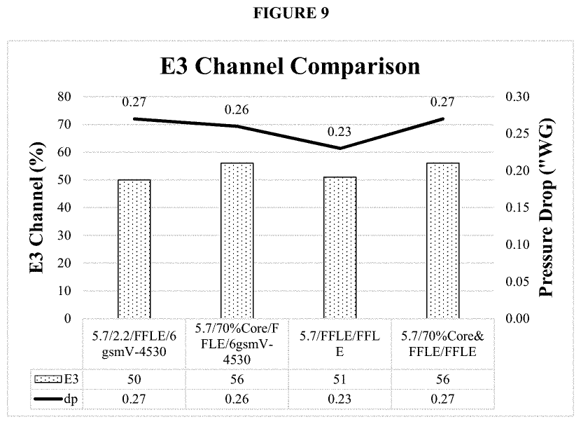

Additionally, FIG. 9 shows the initial efficiency in the E3 channel and pressure drop for Samples 6A-6D. As shown in FIG. 9, the samples having the high core bicomponent fibers (Samples 6B and 6D) had improved initial efficiency, particularly in the E3 channel, which also improved the estimated MERV. Without being bound to a particular theory, it is believed that this improvement is due to the higher volume of the high core bicomponent fibers, resulting from their thicker cores.

Beyond the E3 channel, the high core bicomponent fibers also appear to improve mechanical stress resiliency of the air filter media when it is used as a 100% layer. An initial study contrasting the caliper of the flat sheet media to the caliper of media taken from the interior of the roll is shown in Table 19, below, which demonstrates that less caliper was lost in Sample 6B as compared to Sample 6A.

TABLE 19

| | Basis | Flat | | Caliper |
|---|---|---|---|---|
| | Weight | Sheet Caliper | Inner Roll | Loss |
| Sample | (gsm) | (mm) | Caliper (mm) | (%) |
| 6A | 62 | 2.33 | 0.76 | −68% |
| 6B | 58 | 2.20 | 0.84 | −62% |

### Example 7: Micro-CT Analysis of Various Fibers and Layer Compositions

This Example demonstrates the use of micro computed tomography (“micro-CT”) analysis to characterize several materials in accordance with the present disclosure.

Commercially available ESE452ALV 5.7 dtex and ESE430ALV 3.3 dtex eccentric polyethylene/polypropylene (PE/PP) bi-component fibers in 4 mm fiber lengths from Fibervisions (Varde, Denmark) were used in the materials of this Example. ESE420ALV 2.2 dtex eccentric polyethylene/polypropylene (PE/PP) bicomponent fibers in 6 mm fiber lengths and experimental ESE452ALB 5.7 dtex eccentric polyethylene/polyester (PE/PET) bi-component fibers featuring an Airlaid specific filtration finish from Fibervisions (Varde, Denmark) were also used. Commercially available Trevira-1661 2.2 dtex, 6 mm and high-performance Trevira-255 1.7 dtex, 6 mm concentric polyethylene/polyester (PE/PET) bicomponent fibers from Trevira (Varde, Denmark) were also used. Commercially available Foley FFLE+, an Aluminum-treated pulp made by GP Cellulose, and Vinnapas 192, a commercially available binder from Wacker (Allentown, Pa.), were also used. Ten sample substrates were tested, as shown in Table 20, below.

TABLE 20

| Sample | Substrate Composition |
|---|---|
| 7A | 100% 50 gsm 5.7 dtex Eccentric PE/PP 4 mm |
| 7B | 100% 5.7 dtex Eccentric PE/PET 6 mm Filtration Finish |
| 7C | 100% 3.3 dtex Eccentric PE/PP 4 mm |
| 7D | 100% 2.2 dtex Eccentric PE/PP 4 mm |
| 7E | 100% 2.2 dtex Trevira-1661 |
| 7F | 100% 1.7 dtex T-255 High Core Fiber |
| 7G | 30% 1.7 dtex Trevira-255 High Core/70% FFLE+ |
| 7H | 30% 2.2 dtex Trevira-1661/70% FFLE+ |
| 7I | 28% 1.7 dtex Trevira-255 High Core/66% FFLE+/6% V-192 |
| 7J | 28% 2.2 dtex Trevira-1661/66% FFLE+/6% V-192 |

For each sample, a single-layer 50 gsm structure was prepared on a lab pad former. All hand sheets were subjected to micro computed tomography (“micro-CT”) for evaluation of the fiber volumes present in each sample. A Bruker Skyscan 1272 Micro-CT was used for data collection. Specimens sized about 1.5 cm×2.5 cm were mounted in a specimen fixture such that the specimens were held rigidly in a planar fashion to eliminate deflection or movement during scanning (keeping the rotation axis in-plane). Fiducials were imparted to the specimens to allow orientation to be determined if necessary. Acquisitions were performed using tube conditions of 35 kV and 230 uA with no filtration and 772 ms exposures. The camera was set to a binning level of two yielding 2452×1640 projection images with 2.5 μm pixels. Projection images were collected at rotational increments of 0.2 degrees with six frames averaged per position. The above conditions resulted in scan collection times of roughly 1.5 hours per specimen.

Subsequently, the projection images were post-processed with NRecon and GPUReconServer to compute a three-dimensional volume. Beam hardening was set to zero, with a ring artifact correction of 15. A Gaussian 3×3 smoothing was applied to the dataset. A region of interest (ROI) is defined such that the specimen fixture is excluded from the resulting dataset.

The reconstructed three-dimensional volumes were analyzed to obtain the fiber (object) size distribution and porosity values for each of three nominally equal sized volumes of interest (VOI) representing the upper surface zone, middle and bottom surface zone of each specimen. To establish the VOI, the dataset was loaded, and an upper and lower boundary established to exclude the terminal ends of the specimen to eliminate potential specimen disruption due to cutting. Roughly a dozen sections were inspected within these boundaries and the nominal thickness of the structure noted. The minimum thickness thus recorded was then divided by three to obtain the height for the region of interest (ROI) for this zone. The width of the ROI included most of the section length with the extremes being excluded so that any disruption to the specimen due to cutting was eliminated. Once the ROI was sized as described above, it was positioned at the top of the cross-section. The sections were then visually compared against the ROI and the position of the later adjusted if required (with linear interpolation employed between adjusted ROIs). When the entire stack of sections had been inspected, the dataset was extracted from the ROI yielding the VOI for the zone. This process was then repeated for the center and bottom zone by moving the position of the ROI such that the ROI for the middle zone was just below and touching the upper zone and the ROI for the lower zone was just below and touching the middle zone.

Each of the three zones was then reloaded and the dataset thresholded using a global method with attenuation values between 42 and 255. A despeckle operator was applied to remove white objects in 2D space having less than eight pixels. Finally, a 3D analysis was performed on the resulting VOI.

By dividing the measured permeability by the calculated fiber volumes, the Fibrous Network Index (FNI) was calculated to characterize the structural characteristics of the fibrous network created by a given fiber or fiber blend. FNI is calculated in the following manner:

FNI=(Permeability, in cfm, of 50 gsm fibrous network layer)/(Fiber Volume, in %, of this fibrous network layer) [ft/(min %)]

FNI [cm/s]=0.0197 FNI [ft/(min %)]

The types of fibrous networks shown in Table 21 below, are typical of the layers used as structural components in the airlaid nonwoven air filter media of the presently disclosed subject matter.

TABLE 21

| | | Basis | | | Fiber | FNI | |
|---|---|---|---|---|---|---|---|
| | | Weight | Caliper | Permeability | Volume | (ft/(min | FNI |
| Sample | Description | (gsm) | (mm) | (cfm) | (%) | %)) | (cm/s) |
| 7A | 5.7 dtex | 50 | 2.52 | 1100 | 2.56 | 430 | 8.5 |
| | Eccentric | | | | | | |
| | PE/PP, 4 mm | | | | | | |
| 7B | 5.7 dtex | 50 | 2.59 | 1200 | 1.93 | 622 | 12.3 |
| | Eccentric | | | | | | |
| | PE/PET | | | | | | |
| | Filtration | | | | | | |
| | Finish | | | | | | |
| 7C | 3.3 dtex | 50 | 2.48 | 768 | 3.24 | 237 | 4.7 |
| | Eccentric | | | | | | |
| | PE/PP, 4 mm | | | | | | |
| 7D | 2.2 dtex | 50 | 2.81 | 632 | 2.78 | 227 | 4.5 |
| | Eccentric | | | | | | |
| | PE/PP, 4 mm | | | | | | |
| 7E | T-1661 | 50 | 1.04 | 502 | 4.86 | 103 | 10.0 |
| 7F | High Core T- | 50 | 0.70 | 344 | 8.15 | 42 | 0.8 |
| | 255 | | | | | | |
| 7G | FFLE/High | 50 | 1.37 | 439 | 3.93 | 112 | 2.2 |
| | Core T-255 | | | | | | |
| 7H | FFLE/T-1661 | 50 | 1.44 | 493 | 3.98 | 124 | 2.4 |
| 7I | FFLE/T- | 53 | 1.28 | 444 | 4.68 | 95 | 1.9 |
| | 1661/V-192 | | | | | | |
| 7J | FFLE/High | 53 | 1.29 | 401 | 4.54 | 88 | 1.7 |
| | Core T-255/V-192 | | | | | | |

The air filter media of the present disclosure are composed of layers of fibers having defined structural characteristics such as fiber thickness (or dtex), fiber length, fiber 3D geometry (crimp, curl) and fiber networks are formed by being bonded together by various bonding techniques used in the airlaid nonwovens technology. The fibrous networks thus have a certain porosity which is characterized in this Example by Void Volume and Fiber Volume and the shapes and sizes of conduits through which the air can pass. The shapes and sizes of such conduits (or open pores) decide how much air will be able to pass through the fibrous network.

FNI combines the porosity aspect of a given fibrous network and the 3D geometry of the porous structure created by this fibrous network. In general, more open fibrous network structures with larger conduits and pore sizes will be characterized by higher FNI values and less open fibrous network structures having smaller conduits and pore sizes will be characterized by lower FNI values.

To further study the materials, 5 sample layered structures (Samples 7K to 70) were prepared according to Table 22, below:

TABLE 22

| Sample 7K | Sample 7N |
|---|---|
| 5.7 dtex Eccentric PE/PP (18.5 gsm) | 3.3 dtex Eccentric PE/PP (10 gsm) |
| GI-4723 (10.2 gsm)/T-1661 (6.6 gsm) | 5.7 dtex Eccentric PE/PP (10 gsm) |
| GI-4723 (22 gsm) | FFLE+ (31.5 gsm)/T-257 (5.5 gsm) |
| V-192 (2.7 gsm) | V-4530 (3 gsm) |
| Sample 7L | Sample 70 |
| 3.3 dtex Eccentric PE/PP (10 gsm) | 5.7 dtex Eccentric PE/PP (10 gsm) |
| 5.7 dtex Eccentric PE/PP (10 gsm) | 5.7 dtex Eccentric PE/PP (10 gsm) |
| FFLE+ (28 gsm)/T-257 (12 gsm) | FFLE+ (31.5 gsm)/T-257 (5.5 gsm) |
| No Binder | V-4530 (3 gsm) |
| Sample 7M | |
| 5.7 dtex Eccentric PE/PP (10 gsm) | |
| 3.3 dtex Eccentric PE/PP (10 gsm) | |
| FFLE+ (28 gsm)/T-257 (12 gsm) | |
| No Binder | |

Sample 7K was prepared on a commercial Dan Webb air laid line, while Samples 7L-70 were prepared on a pilot Dan Webb air laid line. Each structure was analyzed as three layers (the eccentric layer and the two cellulosic blend layers) using micro-CT analysis, the results of which are provided in Table 23, below.

TABLE 23

| | Basis | | | | Average Void | | | Average Fiber | | |
|---|---|---|---|---|---|---|---|---|---|---|
| | Weight | Caliper | Permeability | E3 | Volume (%) | | | Volume %) | | |
| Sample | (gsm) | (mm) | (cfm) | (%) | Top | Center | Bottom | Top | Center | Bottom |
| 7K | 62 | 1.46 | 439 | 72 | 96.17 | 94.02 | 93.91 | 3.82 | 5.96 | 6.09 |
| 7L | 61 | 1.49 | 480 | 65 | 97.35 | 95.9 | 96.63 | 2.65 | 4.1 | 3.36 |
| 7M | 61 | 1.91 | 549 | 63 | 96.70 | 95.42 | 96.66 | 3.29 | 4.58 | 3.34 |
| 7N | 59 | 1.32 | 468 | 68 | 95.80 | 95.03 | 95.63 | 4.2 | 4.97 | 4.37 |
| 7O | 59 | 1.32 | 543 | 70 | 96.91 | 94.95 | 94.96 | 3.09 | 5.05 | 5.04 |

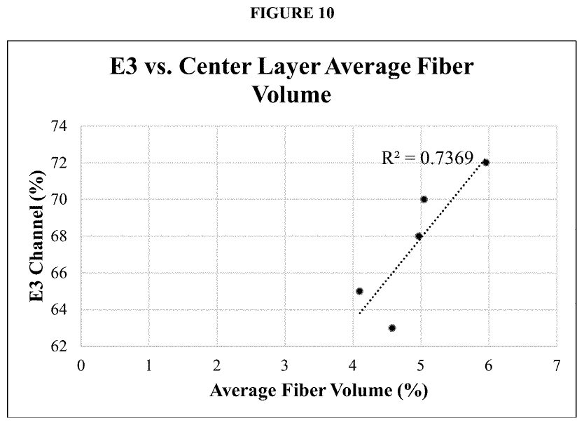

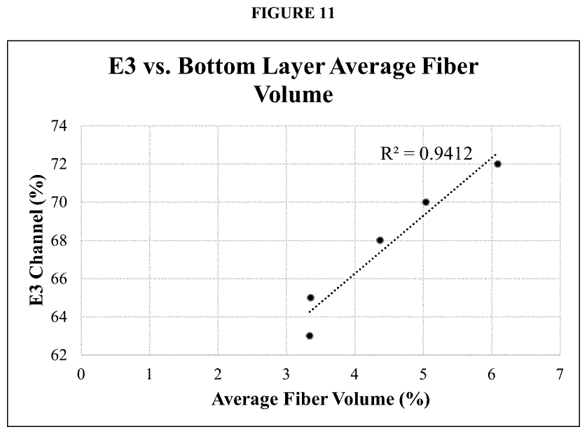

Additionally, the initial efficiency in the E3 channel was compared to the average fiber volume, and an interesting correlation was identified for the cellulosic containing layers, in which initial efficiency in E3 was highly positively correlated with fiber volume, as shown in FIGS. 10 and 11.

### Example 8: Structures Using Eccentric PE/PP Fibers in 6 mm Fiber Lengths with High Core Bicomponent Fibers

This Example provides sample materials that include eccentric PE/PP bicomponent fibers.

The materials of this Example can be made with commercially available ESE452ALV 5.7 dtex and ESE430ALV 3.3 dtex eccentric polyethylene/polypropylene (PE/PP) bi-component fibers in 6 mm fiber lengths from Fibervisions (FV) (Varde, Denmark). Commercially available Trevira-1661 2.2 dtex, 6 mm and 1.7 dtex, 6 mm high core concentric polyethylene/polyester (PE/PET) bicomponent fibers from Trevira (Varde, Denmark) are also used. Commercially available Foley FFLE+, an Aluminum-treated pulp made by GP Cellulose, and Vinnol 4530, a commercially available binder from Wacker (Allentown, Pa.), are used.

Three different grades of air filter media having the structures shown in Table 24 were prepared on a commercial Dan Webb air laid line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

TABLE 24
Sample 8A
FV 3.3 dtex Eccentric PE/PP (9 gsm)
FV 5.7 dtex Eccentric PE/PP (11 gsm)
22% T-255 High Core/FFLE+ (10 gsm)
29% T-1661/FFLE+ (30 gsm)
Sample 8B
FV 3.3 dtex Eccentric PE/PP (12 gsm)
FV 5.7 dtex Eccentric PE/PP (14.5 gsm)
22% T-255 High Core/FFLE+ (10.5 gsm)
29% T-1661/FFLE+ (38 gsm)
Sample 8C
FV 3.3 dtex Eccentric PE/PP (12 gsm)
FV 5.7 dtex Eccentric PE/PP (14.5 gsm)
22% T-255 High Core/FFLE+ (12 gsm)
15% T-1661/FFLE+ (32 gsm)
V-4530 Binder (4.5 gsm)

Multiple rolls of the first two grades were fabricated into 24×24×2 inch wire-backed high capacity filters (with the cellulosic side touching the metal). Only one roll of the third grade (75 gsm MBAL) was fabricated into 24×24×2 inch wire-backed high capacity filters. The finished filters were tested for initial efficiency, initial pressure drop, and dust holding capacity under standard air flow rates proscribed by the ASHRAE 52.2 Test Standard. The characteristics of the filters are summarized in Table 25, below. The initial efficiency and initial pressure drop are provided in Table 26, below.

TABLE 25

| Filter Parameters | | 8A-8C |
|---|---|---|
| # of Pleats | | 29 |
| Nominal Dimensions | in | 24 × 24 × 2 |
| Est. Gross Media Area | ft² | 16.92 |
| Airflow Rate | cfm | 1968 |
| Nominal Face Velocity | ft/min | 492 |

TABLE 26

| | | Master Reel | | Filter Performance | | | | | | |
|---|---|---|---|---|---|---|---|---|---|---|
| | | Caliper | Permeability | Est. | | | | Int. | DHC 1″ | DHC |
| Sample | Descript. | (mm) | (cfm) | MERV | E1 | E2 | E3 | dP | dP | 1.5″ dP |
| 8A | 60 gsm | 1.33 | 484-578 | 8-9 | 6-9 | 39-44 | 70-78 | 0.20- | 96-108 | 98-115 |
| | TBAL | | | | | | | 0.23 | | |
| 8B | 75 gsm | 1.66 | 403-453 | 9 | 8-10 | 45-49 | 76-83 | 0.22- | 90-96 | 95-104 |
| | TBAL | | | | | | | 0.25 | | |
| 8C | 75 gsm | 0.94 | 414-428 | 7-8 | 5-12 | 37-47 | 66-71 | 0.21 | 95 | 102 |
| | MBAL | | | | | | | | | |

As shown in Table 26, the TBAL materials (Samples 8A and 8B) generally had improved estimated MERVs, primarily due to improvements in the E3 channel.

### Example 9: Structures Using 6.7 Dtex Polyester (PET) Fibers

This Example provides sample materials with that include polyester (PET) and modified cellulose fibers.

The materials of this Example were made with 5.7 dtex 5 mm eccentric polyethylene/polyester (PE/PET) bicomponent fibers from Fibervisions (Varde, Denmark). Commercially available Trevira-245 6.7 dtex, 3 mm polyester (PET) mono-component fibers and high core Trevira-255, 1.7 dtex 6 mm PE/PET concentric bicomponent fibers featuring a 70% PET core from Trevira (Varde, Denmark). Commercially available Foley FFLE+, an Aluminum-treated pulp, made by Georgia-Pacific (Foley Mill in Perry, Fla.) and Vinnol 4530, a commercially available binder from Wacker (Allentown, Pa.), was also used in the present example. This Example used mono-component 6.7 dtex PET fibers. Summaries of the compositions are provided Table 27 below.

TABLE 27

| | Sample 9A | Sample 9B |
|---|---|---|
| V-4530 | 5 gsm | 5 gsm |
| 6.7 dtex PET-T-245 | 5 gsm | 10 gsm |
| 5.7 dtex Eccentric PE/PET | 10 gsm | 10 gsm |
| FFLE+/High Core T-255 | 29.6 gsm/7.4 gsm | 29.6 gsm/7.4 gsm |
| V-4530 | 6 gsm | 6 gsm |

The 63 gsm and 68 gsm substrates Samples 9A and 9B were made on a Dan Webb air laid pilot line and slit to a small 19.75 inches wide roll. The roll was then laminated, pleated, and assembled as 20″×20″×2″ filters with 24 pleats each. The finished filters were tested for initial efficiency and pressure drop under standard air flow rates proscribed by the ASHRAE 52.2 Test Standard and resulted in an estimated MERV of 7 with a 0.24 pressure drop. The characteristics of the filters are summarized in Table 28, below.

TABLE 28

| Filter Parameters | | 9A and 9B |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

The initial efficiency and initial pressure drop are provided in Table 29. This example demonstrates that it is possible to substitute the top layer of eccentric for a mixture of 6.7 dtex PET and Vinnol 4530 binder and obtain comparable efficiencies and pressure drops.

TABLE 29

| | Pre-Fabrication Flat Sheet | | | | | | | |
|---|---|---|---|---|---|---|---|---|
| | Analysis | | | Filter Performance | | | | |
| | | | Perme- | | | | | Initial |
| | BW | Caliper | ability | Est. | | | | Pressure |
| Grade | (gsm) | (mm) | (cfm) | MERV | E1 | E2 | E3 | Drop |
| Sample 9A | 66 | 2.02 | 626 | 7 | 6 | 33 | 50 | 0.24 |
| Sample 9B | 68 | 2.18 | 663 | 7 | 6 | 33 | 51 | 0.24 |

### Example 10: Structures Using Eccentric PE/PET Fibers with/without Filtration Finish

This Example provides sample materials that include eccentric polyethylene/polyester (PE/PET) and modified cellulose fibers, with and without filtration finish.

The materials of this Example were made with experimental 5.7 dtex and 3.3 dtex at 5 mm eccentric polyethylene/polyester (PE/PET) bi-component fibers from Fibervisions (FV) (Covington, Ga.) with and without an experimental filtration finish. Commercially available high performance Trevira-255 (4743) 6 mm concentric polyethylene/polyester (PE/PET) bicomponent fibers (Trevira, Varde, Denmark) were also used. Additionally, commercially available Foley FFLE+, an Aluminum-treated pulp made by GP Cellulose, and Vinnol 4530, a commercially available binder from Wacker (Allentown, Pa.), were used in this Example.

Two different grades of air filter media having the structures shown in Table 30 were prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

A roll of each sample was then laminated, pleated, and assembled as 20″×20″×2″ filters with 24 pleats each. The finished filters were tested for initial efficiency and initial pressure drop, and dust holding capacity under standard air flow rates proscribed by the ASHRAE 52.2 Test Standard.

The compositions are summarized in Table 30, below.

TABLE 30
Sample 10A
FV 3.3 dtex Eccentric PE/PET (10 gsm)
FV 5.7 dtex Eccentric PE/PET (10 gsm)
FFLE (29.6 gsm)/High Core T-255 (7.4 gsm)
Vinnol 4530 (6 gsm)
Sample 10B
FV 3.3 dtex Eccentric PE/PET w/Filtration Finish (10 gsm)
FV 5.7 dtex Eccentric PE/PET w/Filtration Finish (10 gsm)
FFLE (29.6 gsm)/High Core T-255 (7.4 gsm)
Vinnol 4530 (6 gsm)

The characteristics of the filters are summarized in Table 31, below.

TABLE 31

| | | |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

The initial efficiency, initial pressure drop, and dust holding capacity (DHC) are provided in Table 32. This example demonstrates that the eccentric PE/PP fibers can be swapped for eccentric PE/PET fibers and obtain similar efficiencies and slightly improved pressure drops. The use of a filtration finish on the eccentric fibers also resulted in a higher DHC and % particle capture in the E2 and E3 channels though an increase in pressure drop was observed.

TABLE 32

| | Pre-Fabrication Flat Sheet | | | Filter Performance | | | | | |
|---|---|---|---|---|---|---|---|---|---|
| | Analysis | | | | | | | Initial | |
| | BW | Caliper | Permeability | Est. | | | | Pressure | |
| Grade | (gsm) | (mm) | (cfm) | MERV | E1 | E2 | E3 | Drop | DHC |
| Sample | 68 | 2.32 | 614 | 7 | 7 | 35 | 53 | 0.22 | 69 |
| 10A | | | | | | | | | |
| Sample | 69 | 2.29 | 605 | 7 | 8 | 41 | 62 | 0.25 | 84 |
| 10B | | | | | | | | | |

### Example 11: Structures Using Fire Retardant Fibers

This Example provides sample materials that include fire retardant fibers.

The materials of this Example can be made using two commercially available eccentric polyethylene/polypropylene (PE/PP) bicomponent fibers from Fibervisions (ESE452ALV, 5.7 dtex, 4 mm and ESE430ALV, 3.3 dtex, 4 mm, Varde, Denmark). Commercially available Trevira-257 1.7 dtex, 6 mm concentric polyethylene/polypropylene (PE/PP) bicomponent fibers (Trevira, Varde, Denmark) can be also used. Additionally, commercially available Foley FFLE+, an Aluminum-treated pulp made by GP Cellulose, and Vinnol 4530, a commercially available binder from Wacker (Allentown, Pa.), can be used. The materials of the present Example also introduced the use of fire retardant polyester (PET) fibers made by Trevira (Varde, Denmark), specifically Trevira-276 2.2 dtex, 6 mm and Trevira-270 1.7 dtex, 6 mm fibers.

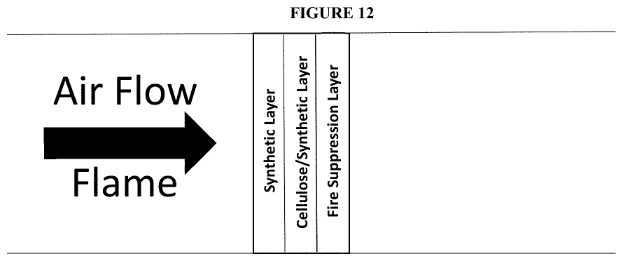

This Example can combine fire retardant fibers and fire-retardant binder. A summary of the compositions are shown in Table 33, below. Additionally, FIG. 12 illustrates the orientation of these sample materials with respect to an air flow and flame.

TABLE 33
Sample 11A
Eccentric Fibers (10-20 gsm)
Bico/Pulp (20-30 gsm)
FR Fibers (5-10 gsm)
FR Binder (5 gsm)
Sample 11B
Eccentric Fibers (10-20 gsm)
Bico/Pulp (20-30 gsm)
FR Fibers/Pulp (20-30 gsm)
FR Binder (5 gsm)
Sample 11C
Eccentric Fibers (10-20 gsm)
Pulp (20-30 gsm)
FR Fibers (5-10 gsm)
FR Binder (1-5 gsm)
Sample 11D
Eccentric Fibers (10-20 gsm)
Bico/Pulp (20-30 gsm)
FR Web (5-20 gsm)

### Example 12: Structures Using Additional Stiffening Binder and 2.2 Dtex Eccentric PE/PP

This Example provides sample materials that include a stiffening binder and eccentric polyethylene/polyester (PE/PET) fibers.

The materials of this Example were made using two commercially available eccentric polyethylene/polypropylene (PE/PP) bicomponent fibers from Fibervisions (ESE452ALV, 5.7 dtex, 4 mm and ESE430ALV, 3.3 dtex, 4 mm, Varde, Denmark). Commercially available Trevira-257 1.7 dtex, 6 mm concentric polyethylene/polypropylene (PE/PP) bicomponent fibers (Trevira, Varde, Denmark) were also used, along with experimental 2.2 dtex, 4 mm eccentric polyethylene/polypropylene (PE/PP) bicomponent fibers (Fibervisions (FV), Varde, Denmark). Commercially available Foley FFLE+, an Aluminum-treated pulp made by GP Cellulose, and Vinnol 4530, a commercially available binder from Wacker (Allentown, Pa.), were also used.

This Example increased the amount of stiffening binder while ensuring uniform spray coverage, as well as further introduce 2.2 dtex eccentric PE/PP into the gradient structures. The compositions are shown in Table 34, below.

Three different grades of air filter media having the structures shown in Table 34 were prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

A roll of each sample was then laminated, pleated, and assembled as 20″×20″×2″ filters with 24 pleats each. The finished filters were tested for initial efficiency and pressure drop under standard air flow rates proscribed by the ASHRAE 52.2 Test Standard.

TABLE 34

| Sample 12A | Sample 12B | Sample 12C |
|---|---|---|
| FV 5.7 dtex (10 gsm) | FV 5.7 dtex (10 gsm) | FV 3.3 dtex (10 gsm) |
| FV 2.2 dtex (10 gsm) | FV 2.2 dtex (10 gsm) | FV 2.2 dtex (10 gsm) |
| 15% T-257/ FFLE+ | 30% T-257/FFLE+ | 15% T-257/FFLE+ |
| (37 gsm) | (40 gsm) | (37 gsm) |
| Vinnol 4530 (6 gsm) | No Binder | Vinnol 4530 (6 gsm) |

The characteristics of the filters are summarized in Table 35, below. The initial efficiency and initial pressure drop are provided in Table 36. This example demonstrates that smaller dtex eccentric fibers deliver slightly increased % particle captures than larger dtex eccentric fibers.

TABLE 35

| | | |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 36

| | Pre-Fabrication Flat | | | | | | | |
|---|---|---|---|---|---|---|---|---|
| | Sheet Analysis | | | Filter Performance | | | | |
| | | | Perme- | | | | | Initial |
| | BW | Caliper | ability | Est. | | | | Pressure |
| Sample | (gsm) | (mm) | (cfm) | MERV | E1 | E2 | E3 | Drop |
| Sample 12A | 63 | 2.36 | 658 | 6 | 8 | 35 | 47 | 0.27 |
| Sample 12B | 58 | 2.20 | 654 | 7 | 10 | 38 | 50 | 0.25 |
| Sample 12C | 62 | 2.33 | 628 | 7 | 11 | 43 | 50 | 0.27 |

### Example 13: Structures Using Alternative Pulp Types

This Example provides sample materials having alternative pulp types, such as mercerized curly pulps and chemically modified pulps.

The materials of this Example were made using two commercially available eccentric polyethylene/polypropylene (PE/PP) bicomponent fibers from Fibervisions (ESE452ALV, 5.7 dtex, 4 mm and ESE430ALV, 3.3 dtex, 4 mm, Varde, Denmark). Commercially available Trevira-257 1.7 dtex, 6 mm concentric polyethylene/polypropylene (PE/PP) bicomponent fibers (Trevira, Varde, Denmark) were also used. Additionally, commercially available Foley FFLE+, an aluminum-treated pulp made by GP Cellulose, and Vinnol 4530, a commercially available binder from Wacker (Allentown, Pa.), were used. Additional pulps used in this example were fully treated GI-4723 and semi-treated GI-4725 made by Georgia-Pacific (New Augusta, Miss.), untreated Eucalyptus (Suzann, Brazil), untreated SB Stora (XX), and untreated Valence (International Paper).

This Example can incorporate one or more of curly pulps (e.g., HPZ) and semi- or fully-treated chemically-modified pulps (e.g., CO™ Pulps) into each structure. However, such samples were not created.

Samples structures can have the compositions shown in Table 37, below. Different potential pulps and their individual fiber characteristics are included in Table 38.

Six different grades of air filter media having the structures shown in Table 37 were prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

A roll of each sample was then laminated, pleated, and assembled as 20″×20″×2″ filters with 24 pleats each. The finished filters were tested for initial efficiency and pressure drop under standard air flow rates proscribed by the ASHRAE 52.2 Test Standard.

TABLE 37

| Sample 13A | Sample 13B |
|---|---|
| 3.3 dtex Eccentric PE/PP (10 gsm) | 3.3 dtex Eccentric PE/PP (10 gsm) |
| 5.7 dtex Eccentric PE/PP (10 gsm) | 5.7 dtex Eccentric PE/PP (10 gsm) |
| FFLE+ Pulp (40 gsm) | GI-4725 Pulp (40 gsm) |
| V-192 (6 gsm) | V-192 (6 gsm) |
| Sample 13C | Sample 13D |
| 3.3 dtex Eccentric PE/PP (10 gsm) | 3.3 dtex Eccentric PE/PP (10 gsm) |
| 5.7 dtex Eccentric PE/PP (10 gsm) | 5.7 dtex Eccentric PE/PP (10 gsm) |
| GI-4723 Pulp (40 gsm) | Valence Untreated Pulp (40 gsm) |
| V-192 (6 gsm) | V-192 (6 gsm) |
| Sample 13E | Sample 13F |
| 3.3 dtex Eccentric PE/PP (10 gsm) | 3.3 dtex Eccentric PE/PP (10 gsm) |
| 5.7 dtex Eccentric PE/PP (10 gsm) | 5.7 dtex Eccentric PE/PP (10 gsm) |
| Stora EF Pulp (40 gsm) | Eucalyptus Pulp (40 gsm) |
| V-192 (6 gsm) | V-192 (6 gsm) |

TABLE 38

| | L. Wt. Avg. | | | | | | |
|---|---|---|---|---|---|---|---|
| | (0.25-7.60 | (0.00-7.60 | % Fines | | Fiber Width | Kajaani | Kink |
| Sample | mm) | mm) | Wt. Avg. | % Fines (n) | (μm) | Curl % | (l/m) |
| Stora LKC | 2.46 | 2.43 | 1.22 | 11.83 | 23.4 | 24.7 | 1300 |
| Biobright | 1.92 | 1.86 | 3.25 | 21.17 | 18.9 | 20.4 | 1350 |
| FSC | | | | | | | |
| Stora EF | 2.24 | 2.17 | 3.57 | 27.37 | 22.2 | 22.9 | 1382 |
| Biobright | 2.02 | 1.96 | 3.33 | 22.55 | 18.6 | 22.7 | 1516 |
| TCF | | | | | | | |
| Steinfurt | 2.59 | 2.54 | 1.88 | 18.46 | 24.6 | 24.0 | 1455 |
| Domtar | | | | | | | |
| Domtar | 2.56 | 2.50 | 2.35 | 21.09 | 24.2 | 23.2 | 1345 |
| Ashdown | | | | | | | |
| Softwood | | | | | | | |
| Eucalyptus | 0.83 | 0.81 | 2.07 | 9.32 | 13.1 | 15.4 | 1857 |
| GI-4723 | 2.85 | 2.79 | 2.31 | 23.26 | 25.5 | 22.4 | 1080 |
| FFLE+ | 2.86 | 2.83 | 1.28 | 13.99 | 26.8 | 21.2 | 795 |
| GI-4725 | 2.84 | 2.78 | 2.40 | 23.86 | 25.6 | 20.9 | 803 |
| GI-4757 | 2.79 | 2.76 | 1.00 | 12.29 | 25.9 | 25.5 | 1411 |

The characteristics of the filters are summarized in Table 39, below. The initial efficiency and initial pressure drop are provided in Table 40.

TABLE 39

| | | |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 40

| | | Pre-Fabrication Flat Sheet | | | | | | | |
|---|---|---|---|---|---|---|---|---|---|
| | | Analysis | | | Filter Performance | | | | |
| | | | | Perme- | | | | | Initial |
| | | BW | Caliper | ability | Est. | | | | Pressure |
| Sample | Description | (gsm) | (mm) | (cfm) | MERV | E1 | E2 | E3 | Drop |
| 13A | FFLE | 70 | 0.98 | 446 | 7 | 12 | 46 | 64 | 0.38 |
| 13B | 4725 | 72 | 0.93 | 315 | 8 | 14 | 51 | 70 | 0.37 |
| 13C | 4723 | 65 | 0.93 | 387 | 8 | 13 | 50 | 72 | 0.37 |
| 13E | Stora | 75 | 1.05 | 294 | 10 | 18 | 62 | 81 | 0.46 |
| 13F | Eucalyptus | 70 | 0.87 | 102 | 11 | 44 | 84 | 88 | 1.01 |

Table 41 provides flat sheet testing data including estimated MERV and resistance. The use of pulps with lower width fibers leads to increased efficiency, permeability and pressure drop in both filter and flat sheet testing. Table 42 provides the percent (%) fiber volume present in the cellulosic bottom layer and its comparison to percent (%) particle capture in the E3 channel. These results demonstrate that an increased fiber volume in the cellulosic layer typically leads to higher % particle capture in the E3 channel and reduced permeability.

TABLE 41

| | | Flat Sheet Performance | | | | |
|---|---|---|---|---|---|---|
| | | Estimated | | | | |
| Sample | Description | MERV | E1 | E2 | E3 | Resistance |
| 13A | FFLE | 8 | 2 | 24 | 71 | 0.11 |
| 13B | 4725 | 9 | 5 | 26 | 77 | 0.16 |
| 13D | Valence | 9 | 7 | 44 | 77 | 0.20 |
| 13E | Stora | 9 | 8 | 49 | 88 | 0.21 |
| 13F | Euc | 11 | 23 | 75 | 93 | 0.49 |

TABLE 42

| | Basis | | | | Fiber |
|---|---|---|---|---|---|
| | Weight | Caliper | Permeability | | Volume, |
| Sample | (gsm) | (mm) | (cfm) | E3 | % |
| Sample 13A | 70 | 0.98 | 446 | 64 | 10.60 |
| Sample 13B | 72 | 0.93 | 315 | 70 | 11.49 |
| Sample 13C | 65 | 0.93 | 387 | 72 | 9.99 |
| Sample 13D | 72 | 0.92 | 252 | | 14.84 |
| Sample 13E | 72 | 1.05 | 294 | 81 | 12.63 |
| Sample 13F | 70 | 0.87 | 102 | 88 | 16.40 |

A clear correlation can be observed between the % object volume measured in the 7.5 to 12.5 micron range and the E3 channel performance of the filter media.

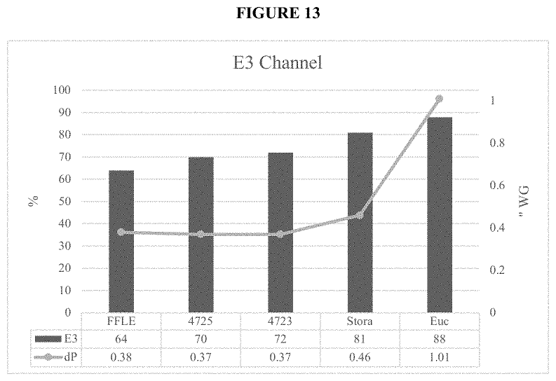

FIG. 13 shows that the use of pulps with lower width fibers leads to increased efficiency and pressure drop. The best performer was Stora EF as it resulted in an increased efficiency with only a minimal increase in pressure drop in comparison to Eucalyptus which resulted in only a slightly better efficiency than Stora but a large increase in pressure drop.

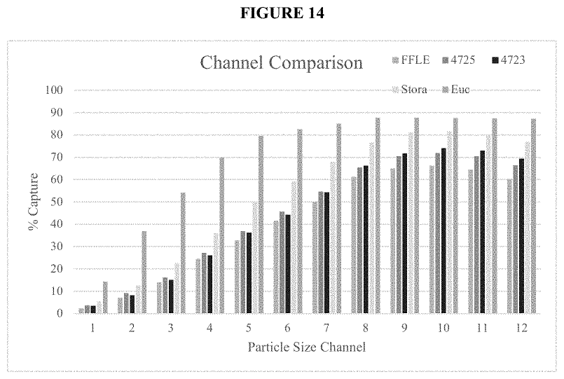

FIG. 14 demonstrates that with the exception of Eucalyptus, most of the % capture changes occur between channels 4-12 (E2 and E3 channels).

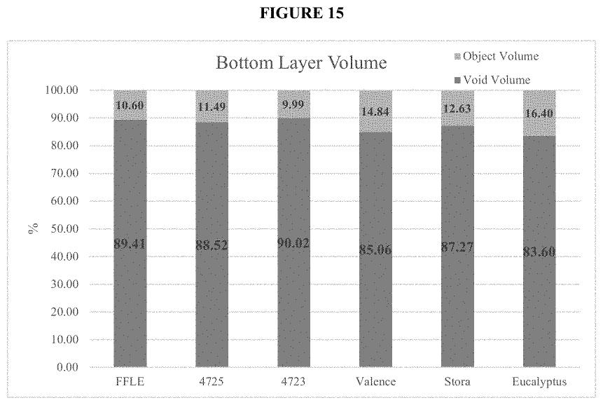

FIG. 15 shows the differing layers of fiber/object volume present in the bottom cellulosic layer of each sample in this study.

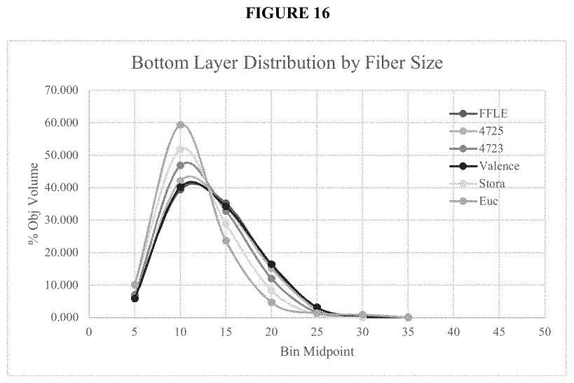

FIG. 16 shows a clear correlation between the fiber/object volume located in the 7.5 to 12.5 micron range to the E3 channel performance. The higher the object volume in this range, the higher the % capture in the E3 channel.

### Example 14: Structures Using Blended Layers

This Example provides sample materials including layers having a blend of synthetic and cellulose fibers and/or a blend of synthetic fibers with different dtex values.

The materials of this Example can be made using two commercially available eccentric polyethylene/polypropylene (PE/PP) bicomponent fibers from Fibervisions (FV) (ESE452ALV, 5.7 dtex, 4 mm and ESE430ALV, 3.3 dtex, 4 mm, Varde, Denmark). Commercially available Trevira-257 1.7 dtex, 6 mm concentric polyethylene/polypropylene (PE/PP) bicomponent fibers (Trevira, Varde, Denmark) are also used. Additionally, commercially available Foley FFLE+, an Aluminum-treated pulp made by GP Cellulose, and Vinnol 4530, a commercially available binder from Wacker (Allentown, Pa.), are used.

The structures of this Example can incorporate blended dtex layers, and, alternatively or additionally, can alternate dtex layers within the gradient structures. For examples, the structures can have the compositions shown in Table 43, below.

TABLE 43
Sample 14A
High/Low dtex Blended Synthetic Fibers
High/Low dtex Blended Synthetic Fibers
Bico/Pulp, Bico/Pulp/Binder, or Pulp/Binder
Sample 14B
High dtex Synthetic Fibers
Low dtex Synthetic Fibers
Low dtex Synthetic Fibers
High dtex Synthetic Fibers
Bico/Pulp, Bico/Pulp/Binder, or Pulp/Binder
Sample 14C
High dtex Synthetic Fibers
Low dtex Synthetic Fibers
High dtex Synthetic Fibers
Low dtex Synthetic Fibers
Bico/Pulp, Bico/Pulp/Binder, or Pulp/Binder

### Example 15: Stability in Conditioning Chamber

This Example provides sample materials that were subjected to conditioning.

The materials of this Example were made using bicomponent fibers from Fibervisions (ESE452ALV, 5.7 dtex, 4 mm, Varde, Denmark). Commercially available Trevira-1661 2.2 dtex, 6 mm concentric polyethylene/polyester (PE/PET) bicomponent fibers were also used. Commercially available Foley FFLE+, an Aluminum-treated pulp, made by GP Cellulose, Golden Isles® 4723, a fully-treated pulp made by GP Cellulose, and Vinnol 4530, a commercially available binder from Wacker (Allentown, Pa.), were also used. The structures of Samples 15A-15E are shown in Table 44, below.

TABLE 44

| Sample 15A | Sample 15D |
|---|---|
| 5.7 dtex Eccentric (20 gsm) | 5.7 dtex Eccentric (20 gsm) |
| FFLE+ (13.3 gsm)/1661 (2.4 gsm) | GI-4723 (13.3 gsm)/1661 (2.4 gsm) |
| FFLE (21.3) | GI-4723 (17 gsm)/1661 (7.3 gsm) |
| V-4530 (6 gsm) | |
| Sample 15B | Sample 15E |
| 5.7 dtex Eccentric (20 gsm) | 5.7 dtex Eccentric (20 gsm) |
| FFLE+ (13.3 gsm)/1661 (2.4 gsm) | FFLE+ (13.3 gsm)/1661 (2.4 gsm) |
| FFLE+ (21.3) | FFLE+ (17 gsm)/1661 (7.2 gsm) |
| V-4530 (3 gsm) | |
| Sample 15C | |
| 5.7 dtex Eccentric (20 gsm) | |
| GI-4723 (13.3 gsm)/1661 (2.4 gsm) | |
| GI-4723 (21.3) | |
| V-4530 (3 gsm) | |

The samples were subjected to exposure in a conditioning chamber set to 100° F. and 90% relative humidity for 6 weeks. Table 45 shows the brightness, whiteness, permeability, caliper, and strength of the materials before and after conditioning. Table 45 also shows the change in these properties due to conditioning.

TABLE 45
Sample

| Property | Conditioning | 15A | 15B | 15C | 15D | 15E |
|---|---|---|---|---|---|---|
| Brightness | Initial | 80.5 | 82.0 | 84.7 | 84.8 | 84.1 |
| (%) | 6 Weeks | 77.0 | 79.5 | 81.1 | 81.5 | 79.4 |
| | Change | −3.5 | −2.5 | −3.5 | −3.4 | −4.7 |
| Whiteness | Initial | 62.7 | 69.9 | 70.4 | 74.9 | 76.8 |
| (%) | 6 Weeks | 60.3 | 63.9 | 66.0 | 71.5 | 68.4 |
| | Change | −2.4 | −6.0 | −4.4 | −3.4 | −8.5 |
| Permeability | Initial | 425 | 494 | 370 | 499 | 480 |
| (cfm) | 6 Weeks | 548 | 559 | 470 | 540 | 550 |
| | Change | 123 | 64 | 100 | 40 | 70 |
| Caliper | Initial | 0.63 | 0.61 | 0.53 | 0.70 | 0.66 |
| (mm) | 6 Weeks | 0.83 | 0.76 | 0.72 | 0.90 | 0.83 |
| | Change | 0.20 | 0.15 | 0.19 | 0.20 | 0.18 |
| MD Dry | Initial | 609.04 | 765.60 | 596.36 | 657.96 | 687.86 |
| Tensile (gli) | 6 Weeks | 758.07 | 535.62 | 454.60 | 896.12 | 620.22 |
| | Change | 149.03 | −229.98 | −141.76 | 238.16 | −67.64 |
| MD Dry | Initial | 16.11 | 17.74 | 16.08 | 18.91 | 17.91 |
| Elongation | 6 Weeks | 17.38 | 14.01 | 16.61 | 18.48 | 17.11 |
| (%) | Change | 1.27 | −3.73 | 0.53 | −0.43 | −0.80 |
| CD Dry | Initial | 478.80 | 597.43 | 501.24 | 444.31 | 464.00 |
| Tensile (gli) | 6 Weeks | 451.89 | 412.46 | 388.50 | 684.19 | 438.97 |
| | Change | −26.91 | −184.97 | −112.74 | 239.88 | −25.03 |
| CD Dry | Initial | 28.68 | 29.41 | 26.48 | 29.94 | 24.91 |
| Elongation | 6 Weeks | 28.34 | 27.58 | 26.28 | 35.48 | 33.44 |
| (%) | Change | −0.34 | −1.83 | −0.20 | 5.54 | 8.53 |

As shown in Table 45, even with 6 weeks of conditioning, there were no substantial changes to the physical characteristics, including the brightness, whiteness, strength, and elongation of the materials.

### Example 16: Nonwoven Materials Having Increased Synthetic Fiber Layers

This Example provides sample materials having larger synthetic fiber layers, e.g., up to 30 gsm, by basis weight.

Samples 16A-16D were made using commercially available ESE452ALV 5.7 dtex 4 mm eccentric polyethylene/polyester (PE/PET) bicomponent fibers from Fibervisions (Varde, Denmark). Commercially available Trevira-1661 2.2 dtex 6 mm concentric polyethylene/polyester (PE/PET) bicomponent fibers from Trevira (Varde, Denmark) were also used. Vinnol 4530, a commercially available binder from Wacker (Allentown, Pa.) and Foley FFLE+, an Al-treated pulp, made by GP Cellulose, were also used.

The structures of Samples 16A-16D are shown in Table 46, below.

TABLE 46

| Sample 16A | Sample 16C |
|---|---|
| 5.7 dtex Eccentric (26.6 gsm) | 5.7 dtex Eccentric (20 gsm) |
| FFLE (17.7 gsm)/T-1661 (3.2 gsm) | FFLE (13.3 gsm)/T-1661 (2.4 gsm) |
| FFLE+ (28.3 gsm) | FFLE+ (21.3 gsm) |
| V-4530 (8 gsm) | V-4530 (6 gsm) |
| Sample 16B | Sample 16D |
| 5.7 dtex Eccentric (26.6 gsm) | 5.7 dtex Eccentric (20 gsm) |
| FFLE (17.7 gsm)/1661 (3.2 gsm) | FFLE (13.3 gsm)/1661 (2.4 gsm) |
| FFLE (22.6 gsm)/1661 (9.7 gsm) | FFLE (17 gsm)/1661 (7.3 gsm) |
| No Binder | No Binder |

Each sample was prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 3 on a FX 3300 Air Permeability Tester set to a test pressure of 125 Pascals. The parameters of each sample are shown in Table 47.

TABLE 47

| Filter Parameters | | 16A-16D |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

Each roll was fabricated into 20×20×2 inch wire-backed high capacity filters (with the cellulosic side touching the metal). The finished filters were tested for initial efficiency and pressure drop under standard air flow rates proscribed by the ASHRAE 52.2 Test Standard. The initial efficiency and initial pressure drop are provided in Table 48, below.

TABLE 48

| | | In-Lab Analysis Pre- | | | Filter Performance | | | | |
|---|---|---|---|---|---|---|---|---|---|
| | | Fabrication | | | | | | | Initial |
| | | BW | Caliper | Permeability | Estimated | | | | Pressure |
| Sample | Description | (gsm) | (mm) | (cfm) | MERV | E1 | E2 | E3 | Drop |
| 16A | 84 gsm | 97 | 2.09 | 379 | 10 | 14 | 57 | 80 | 0.33 |
| | MBAL | | | | | | | | |
| 16B | 63 gsm | 68 | 1.85 | 553 | 7 | 9 | 41 | 66 | 0.24 |
| | MBAL | | | | | | | | |
| 16C | 80 gsm | 86 | 2.23 | 399 | 10 | 13 | 52 | 84 | 0.33 |
| | TBAL | | | | | | | | |
| 16D | 60 gsm | 60 | 1.73 | 566 | 7 | 8 | 40 | 68 | 0.24 |
| | TBAL | | | | | | | | |

As shown in Table 48, the samples having higher basis weights (Samples 16A and 16C) had improved initial efficiency, estimated MERV, and pressure drops.

### Example 17: Structures Comparing Different Bicomponent Fibers in the Bottom Layer

The present example used commercially available ESE452ALV 5.7 dtex 6 mm and ESE430ALV 3.3 dtex 6 mm eccentric polyethylene/polypropylene (PE/PP) bi-component fibers from Fibervisions (Varde, Denmark). Commercially available Trevira-255 (4703) 1.5 dtex, high performance Trevira-255 (4743), and Trevira-255 (1661) 2.2 dtex 6 mm concentric polyethylene/polyester (PE/PET) bicomponent fibers from Trevira (Varde, Denmark) were also used. Commercially available Foley FFLE+, an Aluminum-treated pulp, made by Georgia-Pacific (Foley Mill in Perry, Fla.) and Vinnol 4530, a commercially available binder from Wacker (Allentown, Pa.), were used. A summary of the structures is provided in Table 49.

Five different grades of air filter media having the structures shown in Table 49 were prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

A roll of each sample was then laminated, pleated, and assembled as 20″×20″×2″ filters with 24 pleats each. The finished filters were tested for initial efficiency and pressure drop under standard air flow rates proscribed by the ASHRAE 52.2 Test Standard.

TABLE 49

| Sample 17A | Sample 17B |
|---|---|
| 3.3 dtex Eccentric PE/PP (10 gsm) | 3.3 dtex Eccentric PE/PP (10 gsm) |
| 5.7 dtex Eccentric PE/PP (10 gsm) | 5.7 dtex Eccentric PE/PP (10 gsm) |
| FFLE (28 gsm)/T-255 (1661) | FFLE (28 gsm)/T-255 (1661) |
| 2.2 dtex (12 gsm) | 2.2 dtex (12 gsm) |
| | Vinnol 4530 (6 gsm) |
| Sample 17C | Sample 17D |
| 3.3 dtex Eccentric PE/PP (10 gsm) | 3.3 dtex Eccentric PE/PP (10 gsm) |
| 5.7 dtex Eccentric PE/PP (10 gsm) | 5.7 dtex Eccentric PE/PP (10 gsm) |
| FFLE (28 gsm)/High Core T-255 | FFLE (28 gsm)/High Core T-255 |
| (4743) (12 gsm) | (4743) (12 gsm) |
| | Vinnol 4530 (6 gsm) |
| Sample 17E | |
| 3.3 dtex Eccentric PE/PP (10 gsm) | |
| 5.7 dtex Eccentric PE/PP (10 gsm) | |
| FFLE (28 gsm)/T-255 (4703) | |
| 1.5 dtex (12 gsm) | |

The characteristics of the materials are summarized in Table 50, below. The initial efficiency and initial pressure drop are provided in Table 51.

TABLE 50

| | | |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 51

| | | Pre-Fabrication Flat Sheet Analysis | | | Filter Performance | | | | |
|---|---|---|---|---|---|---|---|---|---|
| | | BW | Caliper | Permeability | Est. | | | | Pressure |
| Sample | Description | (gsm) | (mm) | (cfm) | MERV | E1 | E2 | E3 | Drop |
| 17A | 2.2 dtex | 58 | 1.11 | 574 | 7 | 9 | 40 | 55 | 0.27 |
| | TBAL | | | | | | | | |
| 17B | 2.2 dtex | 66 | 1.32 | 602 | 7 | 9 | 41 | 58 | 0.29 |
| | MBAL | | | | | | | | |
| 17C | High Core | 55 | 1.00 | 586 | 7 | 11 | 45 | 64 | 0.29 |
| | (1.7 dtex) | | | | | | | | |
| | TBAL | | | | | | | | |
| 17D | High Core | 65 | 1.31 | 536 | 7 | 10 | 41 | 57 | 0.29 |
| | (1.7 dtex) | | | | | | | | |
| | MBAL | | | | | | | | |
| 17E | 1.5 dtex | 59 | 1.09 | 559 | 7 | 10 | 43 | 59 | 0.29 |
| | TBAL | | | | | | | | |

The use of high core bico in the bottom layer (1.7 dtex) resulted in the largest increase in efficiency though a slightly higher pressure drop.

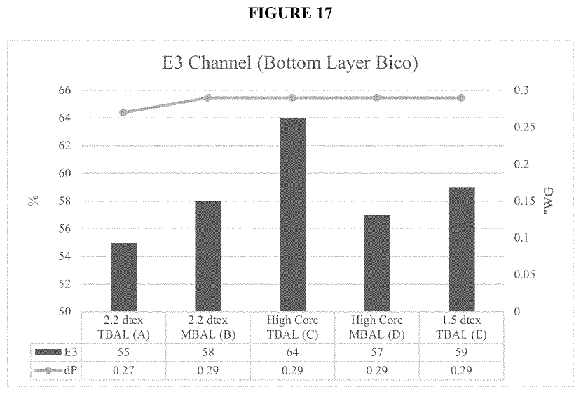

FIG. 17 indicates that High Core Bico results in the largest increase in efficiency of the three bicomponent fibers that were compared with 2.2 dtex testing at the lowest efficiency.

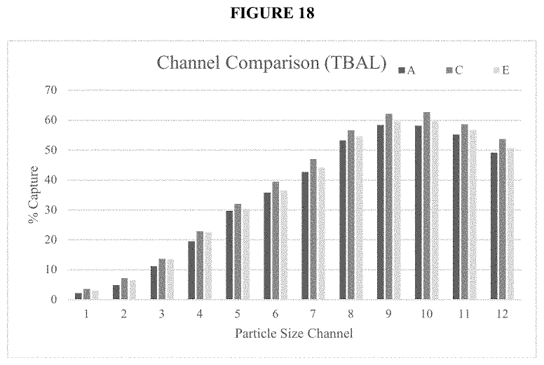

FIG. 18 directly compares the % particle capture of each channel in the three TBAL examples (2.2 dtex, 1.7 dtex, and 1.5 dtex). The high core bico consistently has the highest rate of capture in every channel barring Channel 3 where it ties with 1.5 dtex.

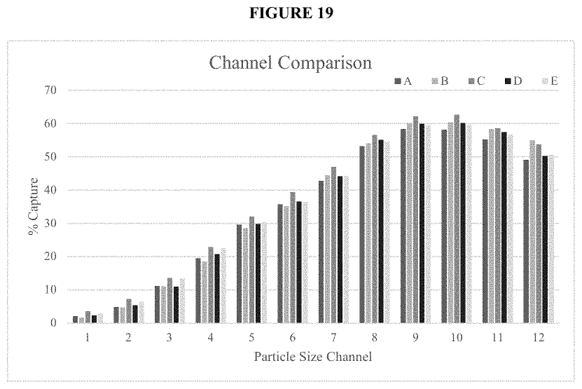

FIG. 19 directly compares the % particle capture of each channel in all 5 structures.

### Example 18: Structures Comparing Different Eccentric Fibers in the Top Layer

The present example used commercially available ESE452ALV 5.7 dtex 6 mm and ESE430ALV 3.3 dtex 6 mm eccentric polyethylene/polypropylene (PE/PP) bi-component fibers from Fibervisions (FV) (Varde, Denmark). Experimental 5.7 dtex and 3.3 dtex 6 mm eccentric polyethylene/polyester bicomponent fibers from Fibervisions (FV) (Varde, Denmark) were used, along with commercially available T-255 6.7 and 2.9 dtex 6 mm eccentric polyethylene/polyester (PE/PET) bicomponent fibers from Trevira (Varde, Denmark). Commercially available high performance Trevira-255 (4743) 1.5 dtex 6 mm concentric polyethylene/polyester (PE/PET) bicomponent fibers from Trevira (Varde, Denmark) were also used. Commercially available Foley FFLE+, an Aluminum-treated pulp, made by Georgia-Pacific (Foley Mill in Perry, Fla.) and Vinnol 4530, a commercially available binder from Wacker (Allentown, Pa.), were used. A summary of the structures is provided in Table 52.

Four different grades of air filter media having the structures shown in Table 52 were prepared on a Dan Webb air laid pilot line. The calipers of each material were measured in millimeters using replicates of 3 (8 measurements per 12×12 inch sample) on a Thwing-Albert Pro Gage. The permeability of each material was measured from the synthetic side in cubic feet/minute using replicates of 4 on a FX 3300 Air Permeability Tester set to a test pressure of 125 Pascals.

A roll of each sample was then laminated, pleated, and assembled as 20″×20″×2″ filters with 24 pleats each. The finished filters were tested for initial efficiency and pressure drop under standard air flow rates proscribed by the ASHRAE 52.2 Test Standard.

TABLE 52

| Sample 18A | Sample 18B |
|---|---|
| FV 3.3 dtex Eccentric | FV 3.3 dtex Eccentric |
| PE/PP (10 gsm) | PE/PP (10 gsm) |
| FV 5.7 dtex Eccentric | Trevira 6.7 dtex Eccentric |
| PE/PP (10 gsm) | PE/PET (10 gsm) |
| FFLE (28 gsm)/T-255 (1661) | FFLE (28 gsm)/T-255 (1661) |
| 2.2 dtex (12 gsm) | 2.2 dtex (12 gsm) |
| Sample 18C | Sample 18D |
| Trevira 2.9 dtex Eccentric | FV 3.3 dtex Eccentric |
| PE/PET (10 gsm) | PE/PET (10 gsm) |
| Trevira 6.7 dtex Eccentric | FV 5.7 dtex Eccentric |
| PE/PET (10 gsm) | PE/PET (10 gsm) |
| FFLE (28 gsm)/High Core | FFLE (28 gsm)/High Core |
| T-255 (4743) (12 gsm) | T-255 (4743) (12 gsm) |

The characteristics of the materials are summarized in Table 53, below. The initial efficiency and initial pressure drop are provided in Table 54. The use of Fibervision (FV) PE/PP or PE/PET eccentric fibers results in consistent efficiency and pressure drop performance. The use of 6.7 dtex eccentric PE/PET and 2.9 dtex eccentric PE/PET resulted in an increase in efficiency and comparable pressure drops.

TABLE 53

| | | |
|---|---|---|
| # of Pleats | | 24 |
| Nominal Dimensions | in | 20 × 20 × 2 |
| Est. Gross Media Area | ft² | 11.67 |
| Airflow Rate | cfm | 1367 |
| Nominal Face Velocity | ft/min | 492 |

TABLE 54

| | Pre-Fabrication Flat Sheet Analysis | | | Filter Performance | | | | |
|---|---|---|---|---|---|---|---|---|
| Sam- | BW | Caliper | Permeability | Est. | | | | Initial |
| ple | (gsm) | (mm) | (cfm) | MERV | E1 | E2 | E3 | Pressure Drop |
| 18A | 58 | 1.11 | 574 | 7 | 9 | 40 | 55 | 0.27 |
| 18B | 60 | 1.17 | 471 | 7 | 9 | 41 | 61 | 0.26 |
| 18C | 58 | 1.08 | 554 | 7 | 12 | 45 | 65 | 0.28 |
| 18D | 57 | 1.37 | 580 | 7 | 9 | 38 | 57 | 0.27 |

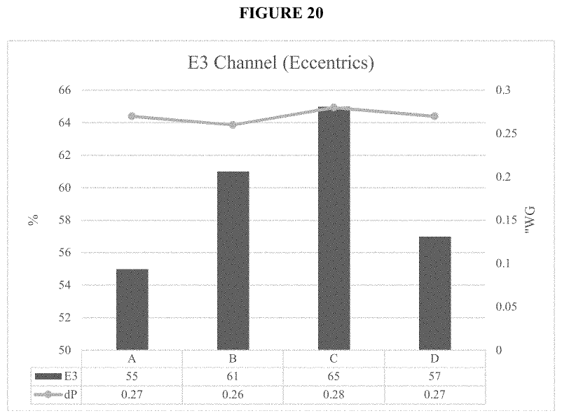

FIG. 20 shows that the use of 6.7 dtex eccentric PE/PET and 2.9 dtex eccentric PE/PET resulted in an increase in efficiency and comparable pressure drops in comparison to the Fibervision eccentric PE/PP and PE/PET samples.

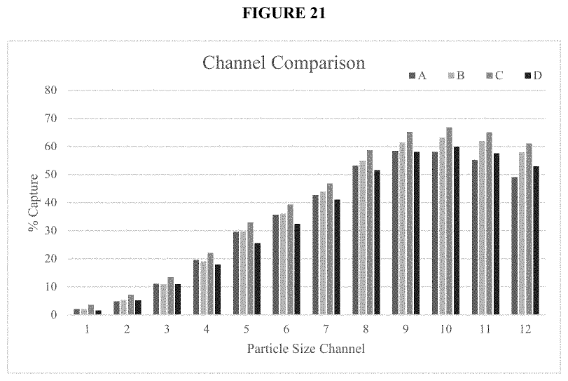

In FIG. 21, Sample C had the highest % particle capture across all channels. Sample B resulted in higher % particle captures than Samples A and D, specifically in the E3 channel range.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

What is claimed is:

1. An air filtration medium, comprising:
a first synthetic fiber layer comprising synthetic fibers and having a first FNI of from about 100 ft/(min %) to about 1000 ft/(min %); and
a cellulose fiber layer having a second FNI that is lower than the first FNI, wherein the second FNI is from about 100 ft/(min %) to about 300 ft/(min %).

2. The air filtration medium of claim 1, wherein the synthetic fibers comprise bicomponent fibers having an eccentric configuration with a sheath comprising polyethylene and a core comprising PET.

3. The air filtration medium of claim 2, wherein the bicomponent fibers have a core to sheath ratio of greater than 1:1.

4. The air filtration medium of claim 1, wherein the synthetic fibers comprise bicomponent fibers having an eccentric configuration with a sheath comprising polyethylene and a core comprising polypropylene.

5. The air filtration medium of claim 1, wherein the first synthetic fiber layer has a basis weight of from about 5 gsm to about 30 gsm.

6. The air filtration medium of claim 5, wherein the first synthetic fiber layer has a basis weight of from about 8 gsm to about 12 gsm.

7. The air filtration medium of claim 1, wherein the cellulose fiber layer has a basis weight of from about 25 gsm to about 100 gsm.

8. The air filtration medium of claim 7, wherein the cellulose fiber layer has a basis weight of about 25 gsm to about 45 gsm.

9. The air filtration medium of claim 1, wherein the first synthetic fiber layer comprises bicomponent fibers having a first length and bicomponent fibers having a second length, wherein the second length is greater than the first length.

10. The air filtration medium of claim 1, wherein the cellulose fiber layer comprises modified cellulose fibers.

11. The air filtration medium of claim 1, wherein the cellulose fiber layer further comprises bicomponent fibers in amount ranging from about 5 wt-% to about 50 wt-% of the cellulose fiber layer.

12. The air filtration medium of claim 11, wherein the bicomponent fibers in the cellulose fiber layer comprise a PET core with a polyethylene sheath and have a dtex of at least about 1.5 dtex.

13. The air filtration medium of claim 1, further comprising a binder on an external surface of the cellulose fiber layer.

14. The air filtration medium of claim 13, wherein the binder is applied in an amount of from about 3 gsm to about 8 gsm.

15. The air filtration medium of claim 1, further comprising a second synthetic fiber layer, disposed between the first synthetic fiber layer and the cellulose fiber layer, having a third FNI that is less than the first FNI and greater than the second FNI.

16. The air filtration medium of claim 15, wherein the third FNI is from about 100 ft/(min %) to about 300 ft/(min %).

17. The air filtration medium of claim 16, wherein the fibers in the second synthetic fiber layer have a dtex that is less than a dtex of the fibers in the first synthetic fiber layer.

18. The air filtration medium of claim 17, wherein the second synthetic fiber layer comprises a blend of cellulose fibers and bicomponent fibers.

19. The air filtration medium of claim 1, further comprising a fire suppression layer disposed adjacent to an outer surface of the cellulose fiber layer and comprising fire retardant fibers.

20. An air filter, comprising a filter housing and the air filtration medium of claim 1.

21. The air filter of claim 20, wherein the air filter has an estimated minimum efficiency reporting value (MERV) of from about 7 to about 9, when tested according to the ASHRAE 52.2 Test Standard.

22. The air filter of claim 20, wherein an initial pressure drop across the air filter is from about 0.17″WG to about 0.32″WG, when measured according to the ASHRAE 52.2 Test Standard.

23. The air filtration medium of claim 1, wherein, when stored in a water bath or conditioning solution, the air filtration medium has no observable mold after a time period of at least 2 weeks.

24. The air filtration medium of claim 1, wherein, when placed in a water bath, the air filtration medium resists full saturation for at least about 5 minutes.
